(19) United States
(12) Patent Application Publication
(10) Pub. No.: US 2023/0306365 A1
(43) Pub. Date: Sep. 28, 2023

(54) APPARATUS, SYSTEM, AND METHOD OF SHIPMENT VETTING

(71) Applicant: Ultra Information Solutions Ltd., Herzliya (IL)

(72) Inventors: Ben Gold, Tel Aviv-Jaffa (IL); Ram Ben Tzion, Ramat Hasharon (IL)

(73) Assignee: Ultra Information Solutions Ltd., Herzliya (IL)

(21) Appl. No.: 18/188,640

(22) Filed: Mar. 23, 2023

Related U.S. Application Data
(60) Provisional application No. 63/323,092, filed on Mar. 24, 2022.

(51) Int. Cl. G06Q 10/0875

(52) U.S. Cl. CPC G06Q 10/0875

(57) ABSTRACT

Some demonstrative aspects include apparatuses, systems and/or methods of shipment vetting. For example, a computing system may process shipment document information corresponding to a plurality of imported shipments to automatically determine a plurality of import inspection recommendations corresponding to the plurality of imported shipments. For example, the computing system may automatically determine an import inspection recommendation corresponding to an imported shipment by processing shipment document information corresponding to the imported shipment to identify a plurality of declared attributes for the imported shipment, the plurality of declared attributes comprising one or more declared goods attributes and one or more declared entity attributes; access one or more databases to retrieve attribute-based information corresponding to the plurality of declared attributes; and determine the import inspection recommendation corresponding to the imported shipment based on the plurality of declared attributes and the attribute-based information.

### CROSS-REFERENCE

This application claims the benefit of and priority from U.S. Provisional Patent Application No. 63/323,092, entitled “SYSTEMS AND METHOD FOR TRADE ANALYSIS SYSTEM”, filed Mar. 24, 2022, the entire disclosure of which is incorporated herein by reference.

### TECHNICAL FIELD

Aspects described herein generally relate to shipment vetting.

### BACKGROUND

Custom authorities control a flow of goods into and out of countries.

There is a need to provide a technical solution to support the relatively complex and time consuming process of custom authorities to vet imports, for example, to collect taxes, to ensure safety, security, and/or the like.

### BRIEF DESCRIPTION OF THE DRAWINGS

For simplicity and clarity of illustration, elements shown in the figures have not necessarily been drawn to scale. For example, the dimensions of some of the elements may be exaggerated relative to other elements for clarity of presentation. Furthermore, reference numerals may be repeated among the figures to indicate corresponding or analogous elements. The figures are listed below.

FIG. 1 is a schematic block diagram illustration of a system, in accordance with some demonstrative aspects.

FIG. 2 is a schematic illustration of an imported-shipments Graphical User Interface (GUI) window of an application, in accordance with some demonstrative aspects.

FIG. 3 is a schematic illustration of an imported-shipment GUI window of an application, in accordance with some demonstrative aspects.

FIG. 4 is a schematic illustration of a plurality of goods-based sub-levels to provide goods-supportive information of specific goods, in accordance with some demonstrative aspects.

FIG. 5 is a schematic illustration of a plurality of entity-based sub-levels to provide entity-supportive information of a specific entity, in accordance with some demonstrative aspects.

FIGS. 6A, 6B and 6C are schematic illustrations of a trade analysis system, in accordance with some demonstrative aspects.

FIG. 7 is a schematic flow chart illustration of a method of providing shipment inspection recommendations, in accordance with some demonstrative aspects.

FIG. 8 is a schematic flow chart illustration of a method of providing shipment inspection recommendations, in accordance with some demonstrative aspects.

FIG. 9 is a schematic illustration of a product of manufacture, in accordance with some demonstrative aspects.

### DETAILED DESCRIPTION

In the following detailed description, numerous specific details are set forth in order to provide a thorough understanding of some aspects. However, it will be understood by persons of ordinary skill in the art that some aspects may be practiced without these specific details. In other instances, well-known methods, procedures, components, units and/or circuits have not been described in detail so as not to obscure the discussion.

Some portions of the following detailed description are presented in terms of algorithms and symbolic representations of operations on data bits or binary digital signals within a computer memory. These algorithmic descriptions and representations may be the techniques used by those skilled in the data processing arts to convey the substance of their work to others skilled in the art.

An algorithm is here, and generally, considered to be a self-consistent sequence of acts or operations leading to a desired result. These include physical manipulations of physical quantities. Usually, though not necessarily, these quantities capture the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers or the like. It should be understood, however, that all of these and similar terms are to be associated with the appropriate physical quantities and are merely convenient labels applied to these quantities.

Discussions herein utilizing terms such as, for example, “processing”, “computing”, “calculating”, “determining”, “establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

The terms “plurality” and “a plurality”, as used herein, include, for example, “multiple” or “two or more”. For example, “a plurality of items” includes two or more items.

References to “one aspect”, “an aspect”, “demonstrative aspect”, “various aspects” etc., indicate that the aspect(s) so described may include a particular feature, structure, or characteristic, but not every aspect necessarily includes the particular feature, structure, or characteristic. Further, repeated use of the phrase “in one aspect” does not necessarily refer to the same aspect, although it may.

As used herein, unless otherwise specified the use of the ordinal adjectives “first”, “second”, “third” etc., to describe a common object, merely indicate that different instances of like objects are being referred to, and are not intended to imply that the objects so described must be in a given sequence, either temporally, spatially, in ranking, or in any other manner.

Some aspects, for example, may capture the form of an entirely hardware aspect, an entirely software aspect, or an aspect including both hardware and software elements. Some aspects may be implemented in software, which includes but is not limited to firmware, resident software, microcode, or the like.

Furthermore, some aspects may capture the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some demonstrative aspects, the medium may be an electronic, magnetic, optical, electromagnetic, infrared, or semiconductor system (or apparatus or device) or a propagation medium.

In some demonstrative aspects, a data processing system suitable for storing and/or executing program code may include at least one processor coupled, directly or indirectly, to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

In some demonstrative aspects, input/output or I/O devices (including but not limited to keyboards, displays, pointing devices, etc.) may be coupled to the system either directly or through intervening I/O controllers. In some demonstrative aspects, network adapters may be coupled to the system to enable the data processing system to become coupled to other data processing systems or remote printers or storage devices, for example, through intervening private or public networks. In some demonstrative aspects, modems, cable modems and Ethernet cards are demonstrative examples of types of network adapters. Other suitable components may be used.

Some aspects may include one or more wired or wireless links, may utilize one or more components of wireless communication, may utilize one or more methods or protocols of wireless communication, or the like. Some aspects may utilize wired communication and/or wireless communication.

Some aspects may be used in conjunction with various devices and systems, for example, a computing device, a mobile device, portable device, a Smartphone, a Personal Computer (PC), a desktop computer, a server computer, a cloud server, a web-based server, a mobile computer, a laptop computer, a notebook computer, a mobile phone, a tablet computer, a handheld computer, a handheld device, a mobile or portable device, a non-mobile or non-portable device, a cellular telephone, a wireless telephone, a device having one or more internal antennas and/or external antennas, a wireless handheld device, or the like.

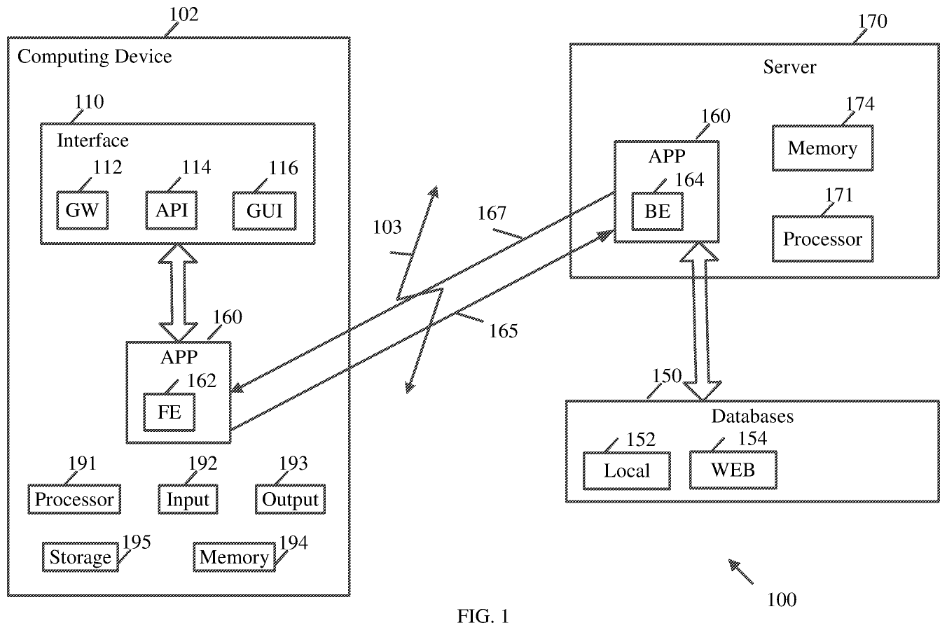

Reference is now made to FIG. 1, which schematically illustrates a block diagram of a system 100, in accordance with some demonstrative aspects.

As shown in FIG. 1, in some demonstrative aspects system 100 may include a computing device 102.

In some demonstrative aspects, device 102 may be implemented using suitable hardware components and/or software components, for example, processors, controllers, memory units, storage units, input units, output units, communication units, operating systems, applications, or the like.

In some demonstrative aspects, device 102 may include, for example, a computing device, a mobile device, a Smartphone, a Personal Computer (PC), a desktop computer, a mobile computer, a laptop computer, a notebook computer, a Cellular phone, a notebook, a tablet computer, a handheld computer, a handheld device, a wireless communication device, or the like.

In some demonstrative aspects, device 102 may include, for example, one or more of a processor 191, an input unit 192, an output unit 193, a memory unit 194, and/or a storage unit 195. Device 102 may optionally include other suitable hardware components and/or software components. In some demonstrative aspects, some or all of the components of one or more of device 102 may be enclosed in a common housing or packaging, and may be interconnected or operably associated using one or more wired or wireless links. In other aspects, components of one or more of device 102 may be distributed among multiple or separate devices.

In some demonstrative aspects, processor 191 may include, for example, a Central Processing Unit (CPU), a Digital Signal Processor (DSP), one or more processor cores, a single-core processor, a dual-core processor, a multiple-core processor, a microprocessor, a host processor, a controller, a plurality of processors or controllers, a chip, a microchip, one or more circuits, circuitry, a logic unit, an Integrated Circuit (IC), an Application-Specific IC (ASIC), or any other suitable multi-purpose or specific processor or controller. Processor 191 may execute instructions, for example, of an Operating System (OS) of device 102 and/or of one or more suitable applications.

In some demonstrative aspects, input unit 192 may include, for example, a keyboard, a keypad, a mouse, a touch-screen, a touch-pad, a track-ball, a stylus, a microphone, or other suitable pointing device or input device. Output unit 193 may include, for example, a monitor, a screen, a touch-screen, a Light Emitting Diode (LED) display unit, a flat panel display, a Liquid Crystal Display (LCD) display unit, a plasma display unit, one or more audio speakers or earphones, or other suitable output devices.

In some demonstrative aspects, memory unit 194 includes, for example, a Random Access Memory (RAM), a Read Only Memory (ROM), a Dynamic RAM (DRAM), a Synchronous DRAM (SD-RAM), a flash memory, a volatile memory, a non-volatile memory, a cache memory, a buffer, a short term memory unit, a long term memory unit, or other suitable memory units. Storage unit 195 may include, for example, a hard disk drive, a Solid State Drive (SSD), or other suitable removable or non-removable storage units. Memory unit 194 and/or storage unit 195, for example, may store data processed by device 102.

In some demonstrative aspects, device 102 may be configured to communicate with one or more other devices via a wireless and/or wired network 103.

In some demonstrative aspects, network 103 may include a wired network, a local area network (LAN), a wireless LAN (WLAN) network, a radio network, a cellular network, a Wireless Fidelity (Wi-Fi) network, a Bluetooth (BT) network, and the like.

In some demonstrative aspects, device 102 may be configured to perform and/or to execute one or more operations, modules, processes, procedures, and/or the like.

In some demonstrative aspects, system 100 may include an application 160, which may be implemented by, as part of, and/or in the form of, at least one service, module, and/or controller, e.g., as described below.

In some demonstrative aspects, application 160 may include, or may be implemented as, software, a software module, an application, a program, a subroutine, instructions, an instruction set, computing code, words, values, symbols, and/or the like.

In some demonstrative aspects, application 160 may include a front-end 162 to be executed by device 102, e.g., as described below.

In some demonstrative aspects, memory unit 194 and/or storage unit 195 may store instructions resulting in front-end 162, and/or processor 191 may be configured to execute the instructions resulting in front-end 162 and/or to perform one or more calculations and/or processes of front-end 162, e.g., as described below.

In other aspects, application 160 may include a back-end 164 to be executed by a suitable computing system, e.g., a server 170.

In some demonstrative aspects, server 170 may include at least a remote server, a web-based server, a cloud server, and/or any other server.

In some demonstrative aspects, device 102 may communicate with server 170, for example, via network 103.

In some demonstrative aspects, the server 170 may include a suitable memory and/or storage unit 174 having stored thereon instructions resulting in back-end 164 of application 160, and a suitable processor 171 to execute the instructions, e.g., as descried below.

In some demonstrative aspects, application 160 may include a combination of back-end 164 and front-end 162.

In some demonstrative aspects, application 160 may be downloaded and/or received by the user of device 102 from another computing system, e.g., server 170, such that front-end 162 may be executed locally by users of device 102. For example, some or all of the instructions of application 160 may be received and stored, e.g., temporarily, in a memory or any suitable short-term memory or buffer of device 102, e.g., prior to being executed by processor 191 of device 102.

In some demonstrative aspects, front-end 162 may be executed locally by device 102, and backend 164 may be executed by server 170.

In some demonstrative aspects, the front-end 162 may include and/or may be implemented as a local application, a web application, a web site, a web client, e.g., a Hypertext Markup Language (HTML) web application, or the like.

In some demonstrative aspects, the back-end 164 may include and/or may be implemented as a remote application, a web server, a Software as a Service (SAS), a cloud service, or the like.

For example, one or more first operations of application 160 may be performed locally, for example, by front-end 162 in device 102, and/or one or more second operations of application 160 may be performed remotely, for example, by back-end 164 in server 170, e.g., as described below.

In other aspects, application 160 may include and/or may be implemented by any other suitable computing arrangement and/or scheme.

In some demonstrative aspects, device 102 may be configured to allow one or more users to interact with one or more processes, applications and/or modules of device 102, e.g., as described herein.

In some demonstrative aspects, system 100 may include an interface 110 to interface between a user of device 102 and one or more elements of system 100, e.g., application 160.

In some demonstrative aspects, interface 110 may be implemented using any suitable hardware components and/or software components, for example, processors, controllers, memory units, storage units, input units, output units, communication units, operating systems, and/or applications.

In some aspects, interface 110 may be implemented as part of any suitable module, system, device, or component of system 100.

In other aspects, interface 110 may be implemented as a separate element of system 100.

In some demonstrative aspects, interface 110 may be implemented as part of device 102. For example, interface 110 may be associated with and/or included as part of device 102.

In one example, interface 110 may be implemented, for example, as middleware, and/or as part of any suitable application of device 102. For example, interface 110 may be implemented as part of application 160 and/or as part of an OS of device 102.

In some demonstrative aspects, interface 110 may be implemented as part of server 170. For example, interface 110 may be associated with and/or included as part of server 170.

In one example, interface 110 may include, or may be part of a Web-based application, a web-site, a web-page, a plug-in, an ActiveX control, a rich content component (e.g., a Flash or Shockwave component), or the like.

In some demonstrative aspects, interface 110 may be associated with and/or may include, for example, a gateway (GW) 112 and/or an application programming interface (API) 114, for example, to communicate information and/or communications between elements of system 100 and/or to one or more other, e.g., internal or external, parties, users, applications and/or systems.

In some aspects, interface 110 may include any suitable Graphic-User-Interface (GUI) 116 and/or any other suitable interface.

In some demonstrative aspects, application 160 may be configured to perform one or more operations, functionalities, and/or communications of shipment inspection recommendation, shipment vetting, and/or shipment analysis, e.g., as described below.

In some demonstrative aspects, application 160 may be configured to perform the one or more operations, functionalities, and/or communications of shipment inspection recommendation, shipment vetting, and/or shipment analysis, for example, for a plurality of shipments, for example, imported shipments, e.g., as described below.

Some demonstrative aspects are described herein with respect to shipment inspection recommendation, shipment vetting, and/or shipment analysis corresponding to imported shipments. In other aspects, one or more of the operations and/or functionalities of shipment inspection recommendation, shipment vetting, and/or shipment analysis, e.g., as described herein, may be performed with respect to exported shipments.

In some demonstrative aspects, an imported shipment may include one or more goods, which may be imported from an origin country into a destination country, for example, by an importer, e.g., as described below.

In some demonstrative aspects, the one or more goods may be imported via a port of loading, e.g., in the country of origin, and a port of discharging, e.g., in the country of destination, e.g., as described below.

In some demonstrative aspects, the one or more goods may be carried by a vessel, which may travel between the port of loading and the port of discharging, e.g., as described below.

In some demonstrative aspects, the vessel may include one or more containers to contain the one or more goods of the imported shipment, e.g., as described below.

In some demonstrative aspects, customs and/or tax authorities of a destination country may vet and/or analyze the imported shipment, for example, to collect revenues for the destination country.

In one example, the revenues may include, for example, import customs, duty taxes, import taxes, and/or the like.

In some demonstrative aspects, the customs and/or tax authorities may vet and/or analyze the imported shipment, for example, to ensure security of the destination country.

In one example, the customs and/or tax authorities may vet and/or analyze the imported shipment, for example, to ensure the goods are not prohibited from being imported into the destination country.

In some demonstrative aspects, the customs and/or tax authorities may vet and/or analyze the imported shipment, for example, to ensure safety of the goods.

In one example, the customs and/or tax authorities may vet and/or analyze imported vehicles, for example, to ensure that one or more imported vehicles are not defective and/or damaged, e.g., after an accident.

In some demonstrative aspects, the customs and/or tax authorities may vet and/or analyze the imported shipment for any other additional or alternative purpose.

In some demonstrative aspects, application 160 may be configured to provide a technical solution to support automatic inspection, vetting and/or analysis of a plurality of shipments, for example, the plurality of imported shipments, e.g., as described below.

In some demonstrative aspects, an imported shipment may be handled, shipped, processed, and/or received, by one or more entities (“shipment-related entities”), e.g., as described below.

In some demonstrative aspects, an entity of the one or more shipment-related entities, may include a company, an agent, an infrastructure, an organization, and/or the like.

In some demonstrative aspects, the one or more shipment-related entities may include an exporter, e.g., as described below.

In some demonstrative aspects, the exporter may include an entity, which may provide the exported shipment at the origin country.

In one example, the exporter may sell one or more goods of the imported shipment.

In other aspects, the exporter may include any other suitable entity.

In some demonstrative aspects, the one or more shipment-related entities may include a forwarder, e.g., as described below.

In some demonstrative aspects, the forwarder may include an entity, which may handle, arrange, and/or transfer the imported shipment at the origin country.

In one example, the exporter may hire the forwarder, for example, to handle, arrange, and/or transfer the imported shipment.

For example, the forwarder may transfer the imported shipment from storage, a logistic center, or the like, of the exporter, e.g., to the port of loading.

For example, the forwarder may arrange local delivery of the imported goods, for example, via local shipping companies, e.g., to the port of loading.

In other aspects, the forwarder may include any other suitable entity.

In some demonstrative aspects, the one or more shipment-related entities may include the port of loading in the origin country, e.g., as described above.

In some demonstrative aspects, the port of loading may include a shipping port in the origin country, at which the goods of the imported shipment are loaded into a vessel, e.g., a ship, a train, a truck, an airplane or the like.

In other aspects, the port of loading may include any other suitable port.

In some demonstrative aspects, the one or more shipment-related entities may include the port of discharging in the destination country, e.g., as described above.

In some demonstrative aspects, the port of discharging may include a shipping port in the destination country, at which the goods of the imported shipment are unloaded from the vessel, e.g., the ship.

In other aspects, the port of discharging may include any other suitable port.

In some demonstrative aspects, the one or more shipment-related entities may include the vessel carrying the imported goods, e.g., as described above.

In some demonstrative aspects, the one or more shipment-related entities may include one or more containers on the vessel which may contain the imported goods, e.g., as described above.

In some demonstrative aspects, the one or more shipment-related entities may include a broker, e.g., as described below.

In some demonstrative aspects, the broker may include an entity, which may manage, arrange, and/or handle an operational part of the imported shipment with the custom authorities at the destination country, for example, before transferring the imported shipment to the importer.

In one example, the importer may hire the broker, for example, to handle, arrange, and/or transfer the imported shipment in the destination country.

In one example, the broker may prepare and/or submit documentation to notify and/or obtain custom clearance from the custom authorities, and/or any other government regulation agencies.

In another example, the broker may arrange local delivery of the imported goods, for example, via local shipping companies, from the port of discharging to a store or a logistics center of the importer.

In other aspects, the broker may include any other suitable entity.

In some demonstrative aspects, the one or more shipment-related entities may include an importer, e.g., as described below.

In some demonstrative aspects, the importer may include an entity, which may handle, arrange, and transfer the imported shipment at the destination country.

In one example, the importer may buy the goods of the imported shipment from the exporter.

In one example, the importer may transfer the imported shipment from the port of discharging, for example, to a storage and/or a logistics center of the importer, for example, after custom clearance is obtained from the custom authorities of the destination country, e.g., by the broker.

In other aspects, the importer may include any other suitable entity.

In some demonstrative aspects, the one or more shipment-related entities may include any other additional and/or alternative entities, which may handle, ship, process, send, and/or receive the imported shipment.

In some demonstrative aspects, application 160 may be configured to automatically vet, inspect and/or analyze an imported shipment, for example, based on vetting, inspection, and/or analysis of the one or more entities handling and/or processing the imported shipment, e.g., as described below.

In one example, application 160 may be configured to automatically vet, inspect and/or analyze an imported shipment, for example, based on vetting, inspection, and/or analysis of the exporter of the imported shipment, e.g., as described below.

In another example, application 160 may be configured to au automatically vet, inspect and/or analyze an imported shipment, for example, based on vetting, inspection, and/or analysis of the forwarder of the imported shipment, e.g., as described below.

In another example, application 160 may be configured to automatically vet, inspect and/or analyze an imported shipment, for example, based on vetting, inspection, and/or analysis of the port of loading and/or the port of discharging of the imported shipment, e.g., as described below.

In another example, application 160 may be configured to automatically vet, inspect and/or analyze an imported shipment, for example, based on vetting, inspection, and/or analysis of the port of loading and/or the port of discharging of the imported shipment, e.g., as described below.

In another example, application 160 may be configured to automatically vet, inspect and/or analyze an imported shipment, for example, based on vetting, inspection, and/or analysis of the vessel and/or the one or more containers containing the imported shipment.

In another example, application 160 may be configured to automatically vet, inspect and/or analyze an imported shipment, for example, based on vetting, inspection, and/or analysis of the broker of the imported shipment, e.g., as described below.

In another example, application 160 may be configured to automatically vet, inspect and/or analyze an imported shipment, for example, based on vetting, inspection, and/or analysis of the importer of the imported shipment, e.g., as described below.

In another example, application 160 may be configured to automatically vet, inspect and/or analyze an imported shipment, for example, based on vetting, inspection, and/or analysis of any other additional or alternative entity.

In some demonstrative aspects, the goods of the imported shipment may include, for example, a same type of goods, e.g., a specific material.

In some demonstrative aspects, the goods of the imported shipment may include, for example, different types of goods, e.g., different types of chairs.

In some demonstrative aspects, the goods of the imported shipment may include, for example, one or more materials, chemicals, households goods, vehicles, electric devices, electronic devices, and/or the like.

In some demonstrative aspects, the imported shipment may be associated with shipment documentation, e.g., as described below.

In some demonstrative aspects, the shipment documentation may include a Bill of Lading (BOL), e.g., as described below.

In some demonstrative aspects, the shipment documentation may include a declaration, e.g., as described below.

In some demonstrative aspects, the shipment documentation may include any other additional and/or alternative documentation.

In some demonstrative aspects, the shipment documentation may be received by the customs authority of the destination country.

In some demonstrative aspects, the shipment documentation may be submitted to the customs authority of the destination country, for example, by one of the shipment-related entities.

In one example, the shipment documentation may be submitted to the customs authority, for example, by the importer, the broker, and/or any other entity.

In some demonstrative aspects, application 160 may be configured to automatically vet, inspect and/or analyze an imported shipment, for example, based on vetting, inspection, and/or analysis of the shipment documentation of the imported shipment, e.g., as described below.

In some demonstrative aspects, application 160 may be configured to automatically vet, inspect and/or analyze an imported shipment, for example, based on vetting, inspection, and/or analysis of shipment information in a BOL and/or a declaration of the imported shipment, e.g., as described below.

In some demonstrative aspects, the shipment documentation may include goods information with respect to the one or more goods of the imported shipment, e.g., as described below.

In some demonstrative aspects, goods information for a particular (specific) goods may include, for example, physical information of the specific goods, e.g., as described below.

In one example, the physical information may include, for example, a weight of the goods, a quantity of the goods, a volume of the goods, and/or the like.

In another example, the physical information may include any other additional and/or alternative information.

In some demonstrative aspects, the goods information for the specific goods may include, for example, classification information of the specific goods, e.g., as described below.

In one example, the classification information may include, for example, a classification of the specific goods, for example, according to harmonized specific (HS) codes, and/or any other additional or alternative classification.

In another example, the classification information may include, for example, a description of the goods.

In another example, the classification information may include any other additional and/or alternative information.

In another example, the classification information may include, for example, an identity of the specific goods. For example, the classification information may include a vehicle identification number (VIN) for a vehicle.

In some demonstrative aspects, the goods information for the specific goods may include, for example, pricing information of the specific goods, e.g., as described below.

In one example, the pricing information may include, for example, a price of the goods, e.g., a Free On Board (FOB) price, a Custom, Insurance and Freight (CIF) price, and/or the like.

In another example, the pricing information may include any other additional and/or alternative information.

In other aspects, the goods information for the specific goods, may include any other additional or alternative type of information.

In some demonstrative aspects, application 160 may be configured to automatically vet, inspect and/or analyze an imported shipment, for example, based on vetting, inspection, and/or analysis of the goods information in the shipment documentation, e.g., as described below.

In some demonstrative aspects, the shipment documentation may include entity information with respect to the one or more entities that handle and/or process the imported shipment, e.g., as described below.

In some demonstrative aspects, entity information for a particular (specific) entity, e.g., an importer, may include, for example, identification information corresponding to the particular entity, e.g., as described below.

In one example, the identification information may include, for example, a company name, a company ID, a company registration number, and/or the like.

In another example, the identification information may include any other additional and/or alternative information.

In some demonstrative aspects, entity information for the specific entity, e.g., the importer, may include, for example, address information corresponding to the specific entity, e.g., as described below.

In one example, the address information may include, for example, an address of offices of the company, and/or the like.

In another example, the address information may include any other additional and/or alternative information.

In some demonstrative aspects, entity information for the specific entity, e.g., the importer, may include, for example, contact information of the specific entity, e.g., as described below.

In one example, the contact information may include, for example, telephone and/or fax numbers of offices of the entity, and/or the like.

In another example, the contact information may include, for example, Email addresses of the entity, and/or the like.

In another example, the contact information may include any other additional and/or alternative information.

In some demonstrative aspects, entity information for the specific entity, e.g., the importer, may include, for example, web information of the specific entity, e.g., as described below.

In one example, the web information may include, for example, one or more websites of the entity, and/or the like.

In another example, the web information may include any other additional and/or alternative information.

In some demonstrative aspects, application 160 may be configured to automatically vet, inspect and/or analyze an imported shipment, for example, based on vetting, inspection, and/or analysis of the entity information for the one or more entities handling and/or processing the imported shipment, e.g., as described below.

In some demonstrative aspects, application 160 may be configured to provide a technical solution to support vetting of imported shipments, for example, for customs and/or tax authorities, and/or law enforcement personnel, e.g., as described below.

In some demonstrative aspects, application 160 may be configured to provide a technical solution to support empowering custom officials and/or analysts to vet imported shipments, for example, in order to collect revenue effectively, e.g., as described below.

In some demonstrative aspects, application 160 may be configured to provide a technical solution to facilitate trade and/or to ensure national security and/or safety, e.g., as described below.

In some demonstrative aspects, application 160 may be configured to provide a technical solution, which may support customs, tax authorities and/or law enforcement agencies across the globe to inspect almost all, e.g., substantially a hundred percent, of shipments imported into a country, e.g., as described below.

In some demonstrative aspects, application 160 may be configured to inspect the shipment documentation of an imported shipment and to cross check the shipment documentation with data sources, e.g., relevant and/or reliable global data sources, for example, to determine whether or not the shipment documentation is authentic and/or reliable, e.g., as described below.

In some demonstrative aspects, application 160 may be configured to receive and/or analyze the goods information in the shipment documentation, and/or the entity information, e.g., representing a variety of information with respect to some or even all of the entities involved in a transaction of the goods, for example, to detect and/or flag suspicious and/or risky imported shipments, e.g., as described below.

In some demonstrative aspects, application 160 may be configured to present to a user conclusions, e.g., shipment recommendations, for example, for an imported shipment, e.g., even for each imported shipment, for example, using a user interface, e.g., a web interface or any other interface, for example, by flagging the suspicious and/or risky imported shipments, e.g., as described below.

In some demonstrative aspects, application 160 may be configured to screen a large amount e.g., substantially 100%, of shipments imported into a country, for example, to classify an imported shipment, e.g., each imported shipment, as a cleared shipment, or as a flagged shipment for inspection, e.g., as described below.

In some demonstrative aspects, application 160 may be configured to detect and/or predict fraud patterns with respect to entities involved in the imported shipment, e.g., the shipper, vessel, agent, and/or the like, e.g., as described below.

In some demonstrative aspects, application 160 may be configured to detect and/or predict fraud patterns with respect to the goods of the imported shipment, e.g., as described below.

In some demonstrative aspects, application 160 may be configured to provide a profile analysis, e.g., an in-depth profile analysis, on the entities, and/or the goods of the imported shipment, e.g., as described below.

In some demonstrative aspects, application 160 may be configured to provide the profile analysis with respect to a variety of shipment aspects, for example, based on a variety of data sources (“external data sources”) and/or data types, e.g., as described below.

In some demonstrative aspects, application 160 may be configured to analyze raw data in the shipment documentation, e.g., the entity information and/or the goods information, for example, to determine a meaning of the imported goods, for example, to build a profile of the imported shipment, e.g., as described below.

In some demonstrative aspects, application 160 may be configured to collect, retrieve, sort, and/or correlate data for analysis of the imported shipment, for example, by performing operations, e.g., collection and retrieval, sorting and/or correlation, for example, between the raw data in the shipment documentation and information form the external data sources, e.g., as described below.

In some demonstrative aspects, application 160 may be configured to access a plurality of different data sources, e.g., even thousands of data sources, for example, to create a goods profile for the imported goods, and/or an entity profile, for one or more entities, e.g., even each entity, which may be involved in the imported shipment, e.g., as described below.

In some demonstrative aspects, application 160 may be configured to analyze, present and/or store processed insights, e.g., entity profiles, for compliance verification, for example, for shipment analysis, and/or fraud pattern replication, e.g., as described below.

In some demonstrative aspects, application 160 may be configured to provide an import inspection recommendation corresponding to an imported shipment, e.g., as described below.

In some demonstrative aspects, the import inspection recommendation may include a clear recommendation, an inspect recommendation, or a caution recommendation, e.g., as described below. In other aspects, any other additional or alternative inspection recommendation may be implemented.

In some demonstrative aspects, the clear recommendation may indicate that no indicative flags are related to the imported shipment.

In some demonstrative aspects, the caution recommendation may indicate that there may be some issues with the imported shipment, which may require the attention of a user, e.g., a customs officer, e.g., as described below.

In one example, a decision of whether to inspect the imported shipment may be up to the user, e.g., the customs officer.

In some demonstrative aspects, the inspect recommendation may indicate that there may be flags pertaining the imported shipment, which may raise a necessity of inspection of the imported shipment, e.g., as described below.

In other aspects, the import inspection recommendation may include any other additional and/or alternative recommendation.

In some demonstrative aspects, application 160 may be configured to provide a conclusion reasoning for the inspect recommendation, and/or for the caution recommendation, e.g., as described below.

In some demonstrative aspects, application 160 may be configured to provide a plurality of goods-flags corresponding to different types of goods of an imported shipments, for example, in case the imported shipment includes a plurality of containers including a plurality of different goods.

In some demonstrative aspects, application 160 may be configured to provide a plurality of entity-flags corresponding to the plurality of entities involved in the imported shipments, for example, to identify whether each entity may be cleared or flagged, e.g., as described below.

In some demonstrative aspects, application 160 may include and/or may perform the functionality of an imported shipment analyzer, e.g., as described below.

In some demonstrative aspects, application 160 may be configured to perform one or more operations, functionalities, and/or communications of imported shipment vetting of a plurality of imported shipments, for example, for customs authorities, e.g., as described below.

Some demonstrative aspects are described herein with respect to an imported shipment analyzer, e.g., application 160, which may be configured to perform imported shipment vetting of a plurality of imported shipments. In other aspects, the imported shipment analyzer, e.g., application 160, may be configured to perform one or more operations of any other additional or alternative shipment vetting, e.g., with respect to exported shipments.

In some demonstrative aspects, application 160 may be configured to provide a technical solution to support imported shipment vetting, for example, for customs authorities. For example, application 160 may be configured to support the customs authorities to vet and/or analyze a plurality of imported shipments to be inspected by the customs authorities, e.g., as described below.

In some demonstrative aspects, application 160 may be configured to provide a technical solution to support imported shipment vetting of a plurality of imported shipments, for example, a relatively large number of imported shipments, e.g., as described below.

In some demonstrative aspects, application 160, e.g., back-end 164, may be configured to process shipment document information 165 corresponding to a plurality of imported shipments, e.g., as described below.

In some demonstrative aspects, the shipment document information 165 corresponding to an imported shipment may include BOL information of a BOL corresponding to the imported shipment, e.g., as described below.

In some demonstrative aspects, the shipment document information 165 corresponding to the imported shipment may include declaration information of a declaration corresponding to the imported shipment, e.g., as described below.

In other aspects, the shipment document information 165 corresponding to the imported shipment may include any other additional and/or alternative documentation.

In some demonstrative aspects, application 160 may be configured to process the shipment document information 165 corresponding to the plurality of imported shipments, for example, to automatically determine a plurality of import inspection recommendations corresponding to the plurality of imported shipments, e.g., as described below.

In some demonstrative aspects, application 160 may be configured to automatically determine the plurality of import inspection recommendations, for example, by automatically determining an import inspection recommendation corresponding to an imported shipment, e.g., as described below.

In some demonstrative aspects, application 160 may be configured to automatically determine the import inspection recommendation corresponding to the imported shipment, for example, by processing shipment document information 165 corresponding to the imported shipment, e.g., as described below.

In some demonstrative aspects, application 160 may be configured to process the shipment document information 165 corresponding to the imported shipment, for example, to identify a plurality of declared attributes for the imported shipment, e.g., as described below.

In some demonstrative aspects, the plurality of declared attributes may include one or more declared goods attributes, e.g., as described below.

In some demonstrative aspects, the plurality of declared attributes may include one or more declared entity attributes, e.g., as described below.

In other aspects, the plurality of declared attributes may include any other additional and/or alternative attributes.

In some demonstrative aspects, application 160 may be configured to automatically determine the import inspection recommendation corresponding to the imported shipment, for example, by accessing one or more databases 150, e.g., as described below.

In some demonstrative aspects, the one or more databases 150 may include a web database 154, e.g., as described below.

In some demonstrative aspects, the one or more databases 150 may include a local database 152, e.g., as described below.

In other aspects, the one or more databases 150 may include any other additional and/or alternative database.

In some demonstrative aspects, application 160 may be configured to access the one or more databases 150, for example, to retrieve attribute-based information corresponding to the plurality of declared attributes, e.g., as described below.

In some demonstrative aspects, application 160 may be configured to automatically determine the import inspection recommendation corresponding to the imported shipment, for example, by determining the import inspection recommendation corresponding to the imported shipment, for example, based on the plurality of declared attributes and the attribute-based information, e.g., as described below.

In some demonstrative aspects, the import inspection recommendation corresponding to the imported shipment may indicate whether the imported shipment is to be cleared from an import inspection, e.g., as described below.

In some demonstrative aspects, application 160 may be configured to provide an output including import inspection recommendation information 167 based on the plurality of import inspection recommendations, e.g., as described below.

In some demonstrative aspects, the attribute-based information may include goods-based information corresponding to the one or more declared goods attributes, e.g., as described below.

In some demonstrative aspects, application 160 may be configured to determine the import inspection recommendation corresponding to the imported shipment, for example, by determining one or more expected goods-attributes, for example, based on the goods-based information, and determining the import inspection recommendation corresponding to the imported shipment, for example, based on a comparison between the expected goods-attributes and the declared goods attributes, e.g., as described below.

In some demonstrative aspects, the attribute-based information may include entity-based information corresponding to the one or more declared entity attributes, e.g., as described below.

In some demonstrative aspects, application 160 may be configured to determine the import inspection recommendation corresponding to the imported shipment, for example, by determining one or more entity-reliability indicators corresponding to the one or more declared entity attributes, and determining the import inspection recommendation corresponding to the imported shipment, for example, based on the one or more entity-reliability indicators, e.g., as described below.

In some demonstrative aspects, application 160 may be configured to retrieve the attribute-based information, which may include goods-based information corresponding to the one or more declared goods attributes, and/or entity-based information corresponding to the one or more declared entity attributes, e.g., as described below.

In some demonstrative aspects, application 160 may be configured to determine a goods-based recommendation, for example, based on the declared goods attributes and the goods-based information, e.g., as described below.

In some demonstrative aspects, application 160 may be configured to determine an entity-based recommendation, for example, based on the declared entity attributes and the entity-based information, e.g., as described below.

In some demonstrative aspects, application 160 may be configured to determine the import inspection recommendation corresponding to the imported shipment, for example, based on the goods-based recommendation and the entity-based recommendation, e.g., as described below.

In some demonstrative aspects, application 160 may be configured to determine a plurality of goods-based sub-levels including, for example, at least a first goods-based sub-level and a second goods-based sub-level, e.g., as described below.

In some demonstrative aspects, the first goods-based sub-level may include a first plurality of goods-based recommendations, for example, based on the goods-based information, e.g., as described below.

In some demonstrative aspects, the second goods-based sub-level may include a second plurality of goods-based recommendations, for example, based on the first plurality of goods-based recommendations, e.g., as described below.

In some demonstrative aspects, application 160 may be configured to determine the goods-based recommendation, for example, based on the second plurality of goods-based recommendations, e.g., as described below.

In some demonstrative aspects, application 160 may be configured to determine at least a third goods-based sub-level including a third plurality of goods-based recommendations, for example, based on the first plurality of goods-based recommendations, e.g., as described below.

In some demonstrative aspects, the second plurality of goods-based recommendations may be based, for example, on the third plurality of goods-based recommendations, e.g., as described below.

In some demonstrative aspects, the import inspection recommendation information 167 may include goods-based recommendations of one or more of the plurality of goods-based sub-levels, e.g., as described below.

In some demonstrative aspects, application 160 may be configured to determine a plurality of entity-based sub-levels including, for example, at least a first entity-based sub-level and a second entity-based sub-level, e.g., as described below.

In some demonstrative aspects, the first entity-based sub-level may include a first plurality of entity-based recommendations, for example, based on the entity-based information, e.g., as described below.

In some demonstrative aspects, the second entity-based sub-level may include a second plurality of entity-based recommendations, for example, based on the first plurality of entity-based recommendations, e.g., as described below.

In some demonstrative aspects, application 160 may be configured to determine the entity-based recommendation, for example, based on the second plurality of entity-based recommendations, e.g., as described below.

In some demonstrative aspects, application 160 may be configured to determine at least a third entity-based sub-level including a third plurality of entity-based recommendations, for example, based on the first plurality of entity-based recommendations, e.g., as described below.

In some demonstrative aspects, the second plurality of entity-based recommendations may be based, for example, on the third plurality of entity-based recommendations, e.g., as described below.

In some demonstrative aspects, the import inspection recommendation information 167 may include entity-based recommendations of one or more of the plurality of entity-based sub-levels, e.g., as described below.

In some demonstrative aspects, application 160 may be configured to select between a clear recommendation, an inspect recommendation, and a caution recommendation, for example, to determine the import inspection recommendation for the imported shipment, e.g., as described below.

In some demonstrative aspects, the import inspection recommendation information 167 may include information to define a graphic representation configured to display the plurality of import inspection recommendations to a user, e.g., as described below.

In some demonstrative aspects, the one or more declared goods attributes may include a declared goods classification attribute, e.g., as described below.

In some demonstrative aspects, the one or more declared goods attributes may a declared goods physical attribute, e.g., as described below.

In some demonstrative aspects, the one or more declared goods attributes may include a declared goods value attribute, e.g., as described below.

In some demonstrative aspects, the one or more declared goods attributes may include a Harmonized System (HS) product code, e.g., as described below.

In some demonstrative aspects, the one or more declared goods attributes may include a declared gross weight, e.g., as described below.

In some demonstrative aspects, the one or more declared goods attributes may include a declared quantity, e.g., as described below.

In some demonstrative aspects, the one or more declared goods attributes may include a declared volume, e.g., as described below.

In some demonstrative aspects, the one or more declared goods attributes may include declared goods description, e.g., as described below.

In other aspects, the one or more declared goods attributes may include any other additional and/or alternative attributes.

In some demonstrative aspects, the one or more declared entity attributes may include a declared exporter attribute, e.g., as described below.

In some demonstrative aspects, the one or more declared entity attributes may include a declared forwarder attribute, e.g., as described below.

In some demonstrative aspects, the one or more declared entity attributes may include a declared loading port attribute, e.g., as described below.

In some demonstrative aspects, the one or more declared entity attributes may include a declared vessel attribute, e.g., as described below.

In some demonstrative aspects, the one or more declared entity attributes may include a declared discharging port attribute, e.g., as described below.

In some demonstrative aspects, the one or more declared entity attributes may include a declared broker attribute, e.g., as described below.

In some demonstrative aspects, the one or more declared entity attributes may include a declared importer attribute, e.g., as described below.

In some demonstrative aspects, the one or more declared entity attributes may include an entity identifier (ID), e.g., as described below.

In some demonstrative aspects, the one or more declared entity attributes may include an entity address, e.g., as described below.

In some demonstrative aspects, the one or more declared entity attributes may include entity contact information, e.g., as described below.

In some demonstrative aspects, the one or more declared entity attributes may include entity web information, e.g., as described below.

In other aspects, the one or more declared entity attributes may include any other additional and/or alternative attributes.

In some demonstrative aspects, application 160, e.g., front-end 162 of application 160, may be configured to send to a server, e.g., to the server 170 implementing back-end 164 of application 160, shipment document information corresponding to a plurality of imported shipments, e.g., as described below.

In one example, front-end 162 may send to back-end 164 the shipment document information 165 corresponding to the plurality of imported shipments. For example, front-end 162 may send to back-end 164 the shipment document information 165 including the one or more declared goods attributes and the one or more declared entity attributes, e.g., as described above.

In some demonstrative aspects, the shipment document information may include a plurality of declared attributes for the imported shipment, e.g., as described above.

In some demonstrative aspects, the plurality of declared attributes may include one or more declared goods attributes and/or one or more declared entity attributes, e.g., as described above.

In some demonstrative aspects, front-end 162 may be configured to identify, for example, based on import inspection recommendation information from the server 170, a plurality of import inspection recommendations corresponding to the plurality of imported shipments, e.g., as described below.

In some demonstrative aspects, server 170 may determine the plurality of import inspection recommendations corresponding to the plurality of imported shipments, e.g., as described above.

In some demonstrative aspects, the import inspection recommendation corresponding to an imported shipment may be configured to indicate whether the imported shipment is to be cleared, e.g., as described above.

In some demonstrative aspects, the inspection recommendation information from the server, e.g., inspection recommendation information 167, may include a goods-based recommendation for the imported shipment, for example, based on the declared goods attributes, and/or an entity-based recommendation for the imported shipment, for example, based on the declared entity attributes, e.g., as described above.

In some demonstrative aspects, the inspection recommendation information from the server, e.g., inspection recommendation information 167, may include one or more expected goods-attributes corresponding to the one or more declared goods attributes, e.g., as described above.

In some demonstrative aspects, the inspection recommendation information from the server, e.g., inspection recommendation information 167, may include one or more entity-reliability indicators corresponding to the one or more declared entity attributes, e.g., as described above.

In some demonstrative aspects, back-end 164 may provide to front-end 162 import inspection recommendation information 167 including the goods-based recommendations, the entity-based recommendations, and/or the information to define the graphic representation configured to display the plurality of import inspection recommendations to a user, e.g., as described above.

In one example, front-end 162 may identify the plurality of import inspection recommendations corresponding to the plurality of imported shipments, for example, based on import inspection recommendation information 167, e.g., as described above.

In some demonstrative aspects, front-end 162 may be configured to provide a GUI to a user, for example, via GUI 116, e.g., as described below.

In some demonstrative aspects, front-end 162 may be configured to control the GUI 116 to present the plurality of import inspection recommendations corresponding to the plurality of imported shipments, e.g., as described below.

In some demonstrative aspects, front-end 162 may be configured to identify a selection of a imported shipment, for example, based on an input from the user, e.g., as described below.

In one example, the user may select the imported shipment, for example, via GUI 116.

In some demonstrative aspects, front-end 162 may be configured cause the GUI 116 to present the goods-based recommendation for the selected imported shipment and/or the entity-based recommendation for the imported shipment, for example, based on the selection of the imported shipment, e.g., as described below.

In some demonstrative aspects, front-end 162 may be configured to identify a request from the user for supportive information corresponding to the goods-based recommendation for the imported shipment, for example, via GUI 116, e.g., as described below.

In some demonstrative aspects, front-end 162 may be configured to cause, control, and/or instruct the GUI 116 to present the one or more expected goods-attributes corresponding to the one or more declared goods attributes, for example, based on the request from the user for supportive information corresponding to the goods-based recommendation for the imported shipment, e.g., as described below.

In some demonstrative aspects, front-end 162 may be configured to cause, control, and/or instruct the GUI 116 to present the plurality of goods-based sub-levels including the first goods-based sub-level, e.g., including the first plurality of goods-based recommendations, and/or the second goods-based sub-level, e.g., including the second plurality of goods-based recommendations, e.g., as described below.

In some demonstrative aspects, front-end 162 may be configured to cause, control, and/or instruct the GUI 116 to present the third goods-based sub-level, e.g., including the third plurality of goods-based recommendations, for example, based on the first plurality of goods-based recommendations, e.g., as described below.

In some demonstrative aspects, front-end 162 may identify a request from the user for supportive information corresponding to the entity-based recommendation for the imported shipment, for example, via GUI 116, e.g., as described below.

In some demonstrative aspects, front-end 162 may be configured to cause, control, and/or instruct the GUI 116 to present the one or more entity-reliability indicators corresponding to the one or more declared entity attributes, for example, based on the request from the user for supportive information corresponding to the entity-based recommendation for the imported shipment, e.g., as described below.

In some demonstrative aspects, front-end 162 may be configured to cause, control, and/or instruct the GUI 116 to present the plurality of entity-based sub-levels including the first entity-based sub-level, e.g., including the first plurality of entity-based recommendations, and/or the second entity-based sub-level, e.g., including the second plurality of entity-based recommendations, e.g., as described below.

In some demonstrative aspects, front-end 162 may be configured to cause, control, and/or instruct the GUI 116 to present the third entity-based sub-level, e.g., including the third plurality of entity-based recommendations, for example, based on the first plurality of entity-based recommendations, e.g., as described below.

In some demonstrative aspects, front-end 162 may be configured to cause, control, and/or instruct the GUI 116 to present the plurality of import inspection recommendations according to a color-coded graphic representation, e.g., as described below.

In some demonstrative aspects, the color-coded graphic representation may be configured to present an import inspection recommendation corresponding to an imported shipment using a color selected from a predefined set of colors corresponding to a respective plurality of predefined import inspection recommendations, e.g., as described below.

In some demonstrative aspects, back-end 162 may be configured as a client-based application which may be installed on computing device 102.

In some demonstrative aspects, the client-based application may be configured to provide a user interface for one or more users, for example, to vet, inspect, and/or analyze a plurality of imported shipments, e.g., as described below.

In some demonstrative aspects, the client-based application may be configured to provide a user interface for a user, for example, to select an imported shipment of the plurality of imported shipments, to select an entity of the imported shipment, and/or to select one or more specific goods of the imported shipment.

In some demonstrative aspects, the client-based application may be configured to provide a user interface for the user, for example, to input one or more requests, e.g., for supportive information, for example, for the entity of the imported shipment, and/or for the specific goods of the imported shipment, e.g., as described below.

In some demonstrative aspects, the client-based application may be configured to provide a user interface for the user, for example, to output and/or display a plurality of goods recommendations and/or a plurality of entity recommendations for the imported shipment.

In some demonstrative aspects, the client-based application may be configured to provide the user interface to support any other additional and/or alternative inputs and/or outputs.

In some demonstrative aspects, back-end 164 of application 160 may be configured as a server-based application, which may be implemented, for example, by server 170.

In some demonstrative aspects, the server-based application may be configured to control one or more functionalities and/or operations of the imported shipment analyzer.

In some demonstrative aspects, the server-based application may be configured to analyze raw data in the shipment documentation of the imported shipment, e.g., as described below.

In some demonstrative aspects, the server-based application may be configured to retrieve external data from the DBs 150, for example, based on the raw data, e.g., as described below.

In some demonstrative aspects, the server-based application may be configured to determine one or more import inspection recommendations corresponding to an imported shipment, for example, based on analysis of the retrieved data from the DBs 150 and the raw data, e.g., as described below.

In other aspects, the server-based application may be configured to control one or more additional and/or alternative functionalities and/or operations of the imported shipment analyzer.

In some demonstrative aspects, application 160 may be configured to generate and/or control one or more functionalities and/or operations of GUI 116, e.g., to interface the user via interface 111, e.g., as described below.

In some demonstrative aspects, application 160 may be configured to control GUI 116 to control and/or manage the imported shipment analyzer and/or interaction of the user with the imported shipment analyzer, e.g., as described below.

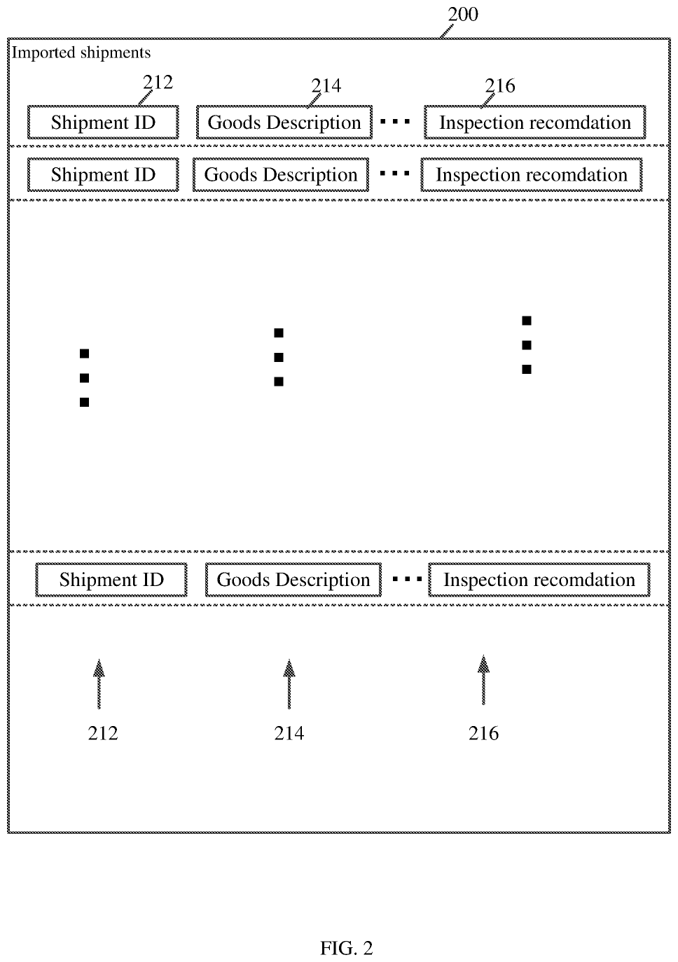

Reference is made to FIG. 2, which schematically illustrates an imported-shipments GUI window 200 of an application, in accordance with some demonstrative aspects.

In some demonstrative aspects, a front-end of an application, e.g., front-end 162 (FIG. 1), may be configured to cause a GUI of the application to display and/or present the imported-shipments GUI window 200.

In some demonstrative aspects, the front-end of the application e.g., front-end 162 (FIG. 1), may be configure to cause the GUI of the application to display and/or present the imported-shipments GUI window 200, for example, in response to, or based on, an input from the user.

In one example, front-end 162 (FIG. 1) may cause, control, and/or instruct GUI 116 (FIG. 1), to display and/or present the GUI window 200 to the user, for example, based on an input from the user, for example, via GUI 116 (FIG. 1).

In some demonstrative aspects, as shown in FIG. 2, imported shipments window 200 may display a summary of vetted imported shipments, e.g., processed by application 160 (FIG. 1).

In one example, imported shipments window 200 may provide an option, via the GUI, to filter the displayed vetted imported shipments based on any suitable criteria, for example, by a time range, goods type, entity type, e.g., countries, ports, and/or the like.

In some demonstrative aspects, as shown in FIG. 2, imported-shipments window 200 may include a plurality of imported shipment IDs 212 corresponding to a respective plurality of imported shipments.

In some demonstrative aspects, an imported shipment ID 212 corresponding to an imported shipment may include a unique identifier to identity the imported shipment.

In some demonstrative aspects, as shown in FIG. 2, imported-shipments window 200 may include a plurality of goods descriptions 214 corresponding to the plurality of imported shipments.

In some demonstrative aspects, a goods description 214 corresponding to the imported shipment ID 212 may include a description of one or more goods associated with the imported shipment.

In some demonstrative aspects, as shown in FIG. 2, imported-shipments window 200 may include a plurality of import inspection recommendations 216 corresponding to the plurality of imported shipments.

In some demonstrative aspects, an import inspection recommendation 216 corresponding to the imported shipment ID 212 may include an indication whether the imported shipment is to be cleared.

In some demonstrative aspects, the import inspection recommendation 216 may include the clear recommendation, the inspect recommendation, or the caution recommendation.

In other aspects, the import inspection recommendation 216 may include any other additional and/or alternative recommendation.

In other aspects, window 200 may include any other additional and/or alternative information with respect to the imported shipments.

In some demonstrative aspects, application 160 (FIG. 1) may be configured to identify a selection of an imported shipment of the plurality of imported shipments, for example, based on an input from the user.

For example, application 160 (FIG. 1) may identify the selection of the imported shipment, for example, based on a selection of the user of the imported shipment ID 212, the goods descriptions 214, and/or the import inspection recommendation 216, e.g., via the GUI 116 (FIG. 1).

In some demonstrative aspects, as shown in FIG. 2, imported shipments window 200 may include an information row per imported shipment.

In some demonstrative aspects, as shown in FIG. 2, the information row may provide a conclusion, e.g., the import inspection recommendation 216, for the imported shipment in the row.

In some demonstrative aspects, the imported shipments window 200 may provide to a user information relating to a large number of imported shipments, while allowing the user to drill down, for example, to investigate, a wide variety of information about a selected imported shipment, e.g., as described below.

In some demonstrative aspects, application 160 (FIG. 1) may be configured to present and/or display to the user an imported-shipment GUI window corresponding to the imported shipment, for example, based on the selection of the imported shipment.

In one example, front-end 162 (FIG. 1) may cause, control, and/or instruct GUI 116 (FIG. 1), to display and/or present to the user the imported-shipment window corresponding to the imported shipment, for example, based on selection of the imported shipment ID 212, the goods descriptions 214, and/or the import inspection recommendation 216.

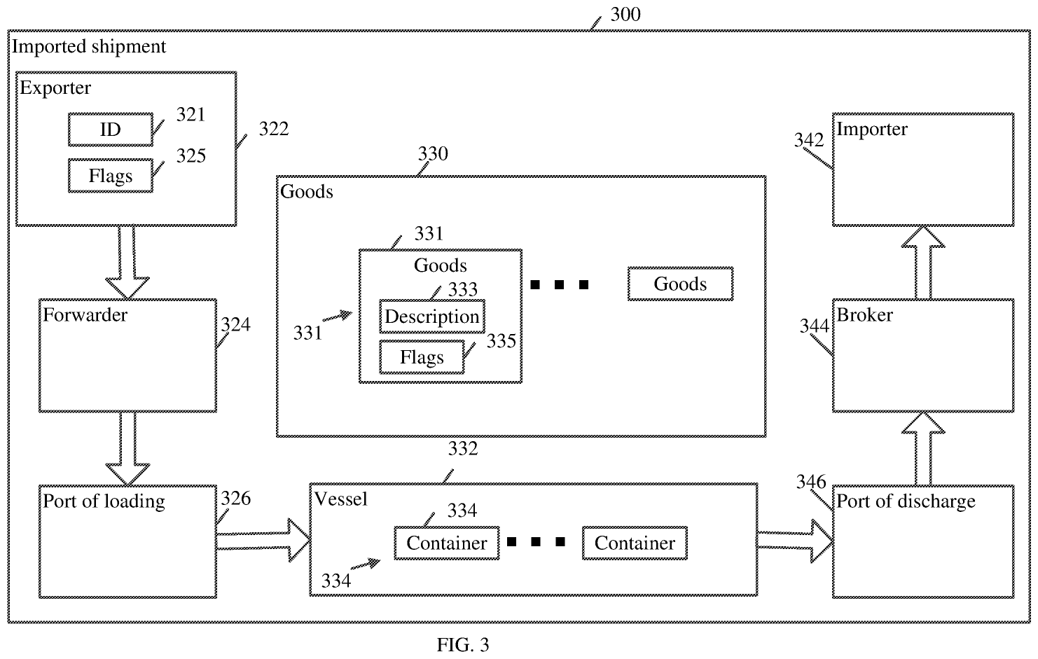

Reference is made to FIG. 3, which schematically illustrates an imported-shipment GUI window 300 of an application, in accordance with some demonstrative aspects.

In some demonstrative aspects, a front-end of an application, e.g., front-end 162 (FIG. 1), may be configured to cause a GUI of the application to display and/or present the imported-shipments GUI window 300.

In some demonstrative aspects, the front-end of the application e.g., front-end 162 (FIG. 1), may be configure to cause the GUI of the application to display and/or present the imported-shipments GUI window 300, for example, in response to, or based on, an input from the user.

In one example, front-end 162 (FIG. 1) may cause, control, and/or instruct GUI 116 (FIG. 1), to display and/or present the GUI window 300 to the user, for example, based on an input from the user, for example, via GUI 116 (FIG. 1) for example, to identify a user selection of imported shipment ID 212 (FIG. 2), the goods descriptions 214 (FIG. 2), and/or the import inspection recommendation 216 (FIG. 2).

In some demonstrative aspects, as shown in FIG. 3, imported-shipment window 300 may include a plurality of entity blocks corresponding to a plurality of entities, which may handle, ship, process, send, and/or receive the imported shipment.

In some demonstrative aspects, as shown in FIG. 3, imported-shipment window 300 may include an exporter block 322 including information corresponding to an exporter of the imported shipment.

In some demonstrative aspects, as shown in FIG. 3, imported-shipment window 300 may include a forwarder block 324 including information corresponding to a forwarder of the imported shipment.

In some demonstrative aspects, as shown in FIG. 3, imported-shipment window 300 may include a port of loading block 326 including information corresponding to a port of loading of the imported shipment.

In some demonstrative aspects, as shown in FIG. 3, imported-shipment window 300 may include a vessel block 332, which may include one or more container blocks 334 including information corresponding to containers of a vessel carrying the imported shipment.

In some demonstrative aspects, as shown in FIG. 3, imported-shipment window 300 may include a port of discharge block 346 including information corresponding to a port of discharge of the imported shipment.

In some demonstrative aspects, as shown in FIG. 3, imported-shipment window 300 may include a broker block 344 including information corresponding to a broker of the imported shipment.

In some demonstrative aspects, as shown in FIG. 3, imported-shipment window 300 may include an importer block 342 including information corresponding to an importer of the imported shipment.

In other aspects, imported-shipment window 300 may include any other additional and/or alternative blocks corresponding to any other additional and/or alternative entity associated with, and/or related to, the imported shipment.

In some demonstrative aspects, an entity block corresponding to an entity, for example, each entity block, of the plurality of entity blocs may include an entity ID of the entity.

In some demonstrative aspects, an entity block corresponding to an entity, for example, each entity block, of the plurality of entity blocs may include one or more flags for the entity.

For example, exporter block 322 may include an entity ID 321 corresponding to an ID of the exporter, and one or more flags 325 for the exporter.

In some demonstrative aspects, the one or more flags 325 corresponding to an entity may be configured to clear the exporter, or to flag one or more inspected entity-attributes with respect to the entity.

In some demonstrative aspects, a clear entity flag corresponding to an entity may indicate that there may be no issues raised for the entity.

In some demonstrative aspects, a flagged entity flag corresponding to an entity may indicate that there may be one or more issues raised for the entity.

In some demonstrative aspects, an entity flag 325 corresponding to an exporter may flag an inspected entity-attribute of the exporter.

In one example, entity flag 325 may flag a legal attribute of the exporter, for example, when it is determined that there are legal cases and/or fines against the exporter.

In another example, entity flag 325 may flag a presence attribute of the exporter, for example, when it is determined that the exporter does not have a webpage.

In another example, entity flag 325 may flag a trade attribute of the exporter, for example, when it is determined that the exporter does not have a certificate for one or more goods in the imported shipment.

In other aspects, an entity flag 325 corresponding to an entity may flag any other additional and/or alternative inspected entity-attributes with respect to the entity.

In some demonstrative aspects, as shown in FIG. 3, imported-shipment window 300 may include a goods block 330 including one or more goods blocks 331 including information corresponding to one or more specific goods of the imported shipment.

In some demonstrative aspects, a goods block 331 corresponding to specific goods, for example, each goods block 331, may include a goods description 333 to describe the specific goods.

In some demonstrative aspects, goods description 333 corresponding to specific goods may include one or more declared goods attributes of the specific goods.

In one example, the one or more declared goods attributes may include, for example, a declared weight of the specific goods, a declared quantity of the specific goods, a declared volume of the specific goods, a declared price of the specific goods, and/or the like.

In some demonstrative aspects, a goods block 331 corresponding to specific goods, for example, each goods block 331, may include one or more flags 335 to flag one or more goods-attributes of the specific goods.

In some demonstrative aspects, a clear flag for the goods may indicate that there may not be issues, e.g., revenue, safety, and/or security issues, for the specific goods of the imported shipment.

In some demonstrative aspects, an inspect flag may indicate that there may be issues, e.g., revenue, safety and/or security issues, for the specific goods of the imported shipment.

In some demonstrative aspects, a caution flag may indicate that there are some issues with the imported shipment, which may require attention of a user, e.g., a customs officer.

In some demonstrative aspects, a first flag 335 may clear the specific goods.

In some demonstrative aspects, a second flag 335 may flag a specific goods-attribute of the specific goods.

In some demonstrative aspects, a variety of goods flags 335 may be displayed in a goods block 331. For example, a different flag may indicate a different type of issue that was detected. For example, the flag may provide an indication of a type of inspection to be performed by the customs officer with respect to the imported shipment.

In some demonstrative aspects, a flag 335 may flag a physical attribute of the specific goods, for example, when the declared weight of the specific goods does not match an expected, e.g., common, weight for the specific goods.

In some demonstrative aspects, a flag 335 may flag a physical attribute of the specific goods, for example, when the declared volume of the specific goods does not match an expected, e.g., common volume for the specific goods.

In some demonstrative aspects, a flag 335 may flag a physical attribute of the specific goods, for example, when the specific goods is determined to be damaged and/or defective.

For example, if a damaged flag 335, e.g., a damaged vehicle flag, is displayed, the customs officer may request supportive information about the vehicle, and/or about an entity that sold the vehicle.

In some demonstrative aspects, a flag 335 may flag an evaluation attribute of the specific goods, for example, when the declared price of the specific goods does not match an expected, e.g., common, price for the specific goods.

In one example, if an evaluation flag 335, e.g., a price flag, is displayed for the specific goods, the customs officer may request supportive information about the pricing of the specific goods, e.g., historical pricing of the specific goods, and/or any suitable common public price for the specific goods.

In some demonstrative aspects, a flag 335 may flag a classification attribute of the specific goods, for example, when a description of the specific goods does not match a declared classification, e.g., HS code, of the specific goods.

In other aspects, any other additional and/or alternative flag 335 may be configured to flag any other goods-attribute of the specific goods.

In some demonstrative aspects, application 160 (FIG. 1) may be configured to identify a request from the user for supportive entity-information corresponding to a specific entity of the one or more entities provided by the window 300.

In some demonstrative aspects, application 160 (FIG. 1) may identify the request from the user for the supportive entity-information corresponding to the specific entity, for example, based on a selection, e.g., a mouse click, or the like, of an entity block from the plurality of entity blocks of window 300.

In one example, application 160 (FIG. 1) may identify the request from the user for supportive exporter-information corresponding to the exporter, for example, based on a selection, e.g., a mouse click, or the like, of the exporter block 322.

In another example, application 160 (FIG. 1) may identify the request from the user for supportive importer-information corresponding to the importer, for example, based on a selection, e.g., a mouse click, or the like, of the importer block 342.

In some demonstrative aspects, application 160 (FIG. 1) may cause the GUI 116 (FIG. 1) to display an entity-supportive information window including entity-supportive information corresponding to the selected entity, e.g., as described below.

In one example, front-end 162 (FIG. 1) may cause, control, and/or instruct GUI 116 (FIG. 1), to display and/or present the entity-supportive information window including entity-supportive information corresponding to the exporter, for example, based on selection of the exporter block 322, flags 325, and/or ID 321 by the user.

In another example, front-end 162 (FIG. 1) may cause, control, and/or instruct GUI 116 (FIG. 1), to display and/or present the entity-supportive information window including entity-supportive information corresponding to the importer, for example, based on selection of the importer block 342 by the user.

In some demonstrative aspects, application 160 (FIG. 1) may identify a request from the user for supportive goods-information corresponding to specific goods of the one or more goods 331.

In some demonstrative aspects, application 160 (FIG. 1) may identify the request from the user for the supportive goods-information corresponding to the specific goods, for example, based on a selection, e.g., a mouse click, or the like, of a goods block 331 from the plurality of goofs blocks 331.

In some demonstrative aspects, application 160 (FIG. 1) may cause the GUI 116 (FIG. 1) to display a goods-supportive information window including goods-supportive information corresponding to the specific goods, e.g., as described below.

In one example, front-end 162 (FIG. 1) may cause, control, and/or instruct GUI 116 (FIG. 1), to display and/or present the goods-supportive information window including goods-supportive information corresponding to a specific goods block 331, for example, based on selection of the specific goods block 331 by the user.

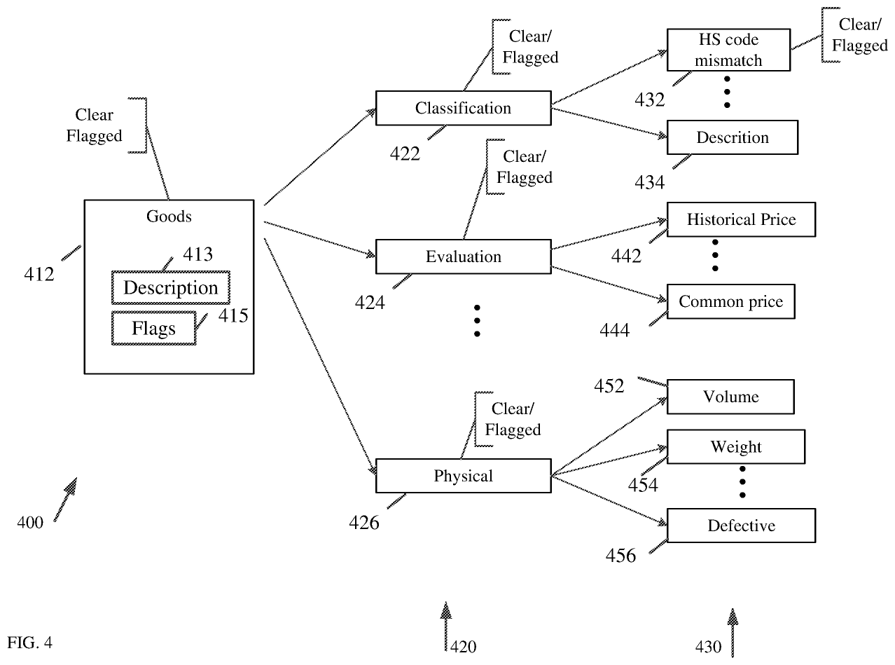

Reference is made to FIG. 4, which schematically illustrates a plurality of goods-based sub-levels to provide goods-supportive information 400 of specific goods, in accordance with some demonstrative aspects.

In some demonstrative aspects, the goods-supportive information 400 of a particular (specific) goods in an imported shipment may be determined based on a plurality of goods-based sub-levels, e.g., as described below.

In some demonstrative aspects, application 160 (FIG. 1), e.g., back-end 164 (FIG. 1), may be configured to determine a goods-based recommendation for the particular goods, for example, based on a plurality of goods-based sub-levels, e.g., as described below.

In some demonstrative aspects, application 160 (FIG. 1), e.g., back-end 164 (FIG. 1), may be configured to determine the goods-based recommendation for the particular goods, for example, based on a goods-based sub-level 420 and/or a goods-based sub-level 430, e.g., as described below.

In some demonstrative aspects, application 160 (FIG. 1), e.g., back-end 164 (FIG. 1), may be configured to determine a first plurality of goods-based recommendations in goods-based sub-level 430, for example, based on the declared goods attributes corresponding to the particular goods and the retrieved goods-based information corresponding to the particular goods, e.g., as described below.

In some demonstrative aspects, application 160 (FIG. 1), e.g., back-end 164 (FIG. 1), may be configured to determine a second plurality of goods-based recommendations in goods-based sub-level 420, for example, based on the first plurality of goods-based recommendations in goods-based sub-level 430 and/or goods-based recommendations in one or more other goods-based sub layers, e.g., as described below.

In some demonstrative aspects, application 160 (FIG. 1), e.g., back-end 164 (FIG. 1), may be configured to determine the goods-based recommendation for the particular goods, for example, based on the second plurality of goods-based recommendations in goods-based sub-level 420 and/or goods-based recommendations in one or more other goods-based sub layers, e.g., as described below.

In some demonstrative aspects, a front-end of an application, e.g., front-end 162 (FIG. 1), may be configured to cause a GUI of the application to display and/or present some or all of the goods-supportive information 400.

In some demonstrative aspects, the front-end of the application e.g., front-end 162 (FIG. 1), may be configured to cause the GUI of the application to display and/or present some or all of the goods-supportive information 400, for example, in response to, or based on, an input from the user to request for supportive information for specific goods of an imported shipment.

In one example, front-end 162 (FIG. 1) may cause, control, and/or instruct GUI 116 (FIG. 1), to display and/or present some or all of the goods-supportive information 400 to the user, for example, based on an input from the user, for example, via GUI 116 (FIG. 1).

In some demonstrative aspects, as shown in FIG. 4, the goods-supportive information 400 may be determined, e.g., by back-end 164 (FIG. 1) and/or presented, e.g., by front-end 162 (FIG. 1), for example, according to an arranged plurality of goods-sub levels, for example, including the first sub-level 420 and the second sub-level 430.

In some demonstrative aspects, the goods-supportive information 400 may include one or more additional sub-levels, e.g., additional to sub-level 420 and the sub-level 430.

In some demonstrative aspects, as shown in FIG. 4, sub level 420 may include a first plurality of goods recommendations, e.g., arranged in a first plurality of blocks.

In some demonstrative aspects, as shown in FIG. 4, sub level 430 may include a second plurality of goods recommendations, e.g., arranged in a second plurality of blocks.

In some demonstrative aspects, the first plurality of goods recommendations in sub level 420 may be based on the second plurality of goods recommendations in sub level 430, e.g., as described below.

In some demonstrative aspects, a block, e.g., each block, of the first plurality of blocks and/or the second plurality of blocks may be displayed and/or presented to a user, e.g., in a separate window.

In some demonstrative aspects, one or more blocks of the first plurality of blocks and/or the second plurality of blocks, e.g., some or all of the blocks, may be displayed and/or presented in a same window.

In some demonstrative aspects, the goods-supportive information 400 may include a goods block 412.

In some demonstrative aspects, as shown in FIG. 4, goods block 412 may include a goods description 413 of the specific goods.

In some demonstrative aspects, goods description 413 may include a description of the specific goods of the imported shipment, e.g., a vehicle, or chairs of the same type.

In some demonstrative aspects, the goods description 413 of the specific goods may include, for example, declared information with respect to the specific goods.

In some demonstrative aspects, the declared information may include a variety of types of information per type of goods, e.g., quantity, weight, volume, price, packages, and/or the like, for example, based on the declared information of the shipment documentation.

In some demonstrative aspects, as shown in FIG. 4, goods block 412 may include one or more flags 415 to flag one or more goods inspected-attributes of the goods, e.g., as cleared, or as flagged.

In some demonstrative aspects, as shown in FIG. 4, sub level 420 may include a plurality of attributes, e.g., including a classification goods-attribute 422, an evaluation goods-attribute 424, and/or a physical goods-attribute 426.

In other aspects, sub level 420 may include any other additional and/or alternative goods-attributes.

In some demonstrative aspects, as shown in FIG. 4, sub level 430 may include plurality of attributes, e.g., including a an HS code mismatch goods-attribute 432, a description goods-attribute 434, and/or any other additional and/or alternative goods-attributes corresponding to the classification goods-attribute 422.

In some demonstrative aspects, a flag of the classification goods-attribute 422 may be set by back-end 164 (FIG. 1), for example, based on flags of the HS code mismatch goods-attribute 432, the description goods attribute 434, and/or any other additional and/or alternative goods-attributes in sub-level 430, which correspond to the classification goods-attribute 422.

For example, the flag of the classification goods-attribute 422 may be set by back-end 164 (FIG. 1), for example, based on a determination that one or more of the flags are set as flagged for the HS code mismatch goods-attribute 432, the description goods attribute 434, and/or any other additional and/or alternative goods-attributes in sub-level 430, which correspond to the classification goods-attribute 422.

In one example, the flag of the classification goods-attribute 422 may be set by back-end 164 (FIG. 1), for example, based on a criterion relating to whether one or more of the flags are set as flagged for the HS code mismatch goods-attribute 432, the description goods attribute 434, and/or any other additional and/or alternative goods-attributes in sub-level 430, which correspond to the classification goods-attribute 422.

In one example, the flag of the classification goods-attribute 422 may be set by back-end 164 (FIG. 1), for example, based on a criterion relating to an identity and/or a count of one or more of the flags, which are set as flagged for the HS code mismatch goods-attribute 432, the description goods attribute 434, and/or any other additional and/or alternative goods-attributes in sub-level 430, which correspond to the classification goods-attribute 422.

In one example, the flag of the classification goods-attribute 422 may be set as flagged by back-end 164 (FIG. 1), for example, based on a determination that at least one flag is set as flagged for the HS code mismatch goods-attribute 432, the description goods attribute 434, and/or any other additional and/or alternative goods-attributes in sub-level 430, which correspond to the classification goods-attribute 422.

In one example, the flag of the classification goods-attribute 422 may be set as flagged by back-end 164 (FIG. 1), for example, based on a determination that at least x>=1 flags are set as flagged for the HS code mismatch goods-attribute 432, the description goods attribute 434, and/or any other additional and/or alternative goods-attributes in sub-level 430, which correspond to the classification goods-attribute 422.

In one example, the flag of the classification goods-attribute 422 may be set as clear by back-end 164 (FIG. 1), for example, based on a determination that no more than y flags are set as flagged for the HS code mismatch goods-attribute 432, the description goods attribute 434, and/or any other additional and/or alternative goods-attributes in sub-level 430, which correspond to the classification goods-attribute 422.

In one example, the flag of the classification goods-attribute 422 may be set as clear by back-end 164 (FIG. 1), for example, based on a determination that no flags are set as flagged for the HS code mismatch goods-attribute 432, the description goods attribute 434, and/or any other additional and/or alternative goods-attributes in sub-level 430, which correspond to the classification goods-attribute 422.

In some demonstrative aspects, an HS code may include a standard multipurpose international product description code created by the World Customs Organization (WCO). For example, the HS code may be used by customs departments throughout the world to identify types of goods that can be shipped.

In some demonstrative aspects, application 160 (FIG. 1), e.g., back-end 164 (FIG. 1), may be configured to analyze historical trade data of other cases with the same declared description and to determine whether other HS codes were specified in the declaration.

In some demonstrative aspects, application 160 (FIG. 1), e.g., back-end 164 (FIG. 1), may be configured to analyze the name of the goods and the HS codes provided by the sender, e.g., in the shipment documentation, for example, to verify whether the description of goods with the HS code actually matches the declared description of the goods provided in the shipment documentation.

In some demonstrative aspects, application 160 (FIG. 1), e.g., back-end 164 (FIG. 1), may be configured to flag the HS code mismatch goods-attribute 432, the description goods-attribute 434, and/or any other additional and/or alternative goods-attributes corresponding to the classification goods-attribute 422, for example, based on the analysis of the declared goods attributes and the retrieved goods-based information from database 150 (FIG. 1).

In some demonstrative aspects, as shown in FIG. 4, sub level 430 may include a historical price goods-attribute 442, a common price attribute 444, and/or any other additional and/or alternative goods-attributes corresponding to the evaluation goods-attribute 424.

In some demonstrative aspects, a flag of the evaluation goods-attribute 424 may be set by back-end 164 (FIG. 1), for example, based on flags of the historical price goods-attribute 442, the common price goods attribute 444, and/or any other additional and/or alternative goods-attributes in sub-level 430, which may correspond to the evaluation goods-attribute 424.

For example, the flag of the evaluation goods-attribute 424 may be set by back-end 164 (FIG. 1), for example, based on a determination that one or more of the flags are set as flagged for the historical price goods-attribute 442, the common price goods attribute 444, and/or any other additional and/or alternative goods-attributes in sub-level 430, which may correspond to the evaluation goods-attribute 424.

In one example, the flag of the evaluation goods-attribute 424 may be set by back-end 164 (FIG. 1), for example, based on a criterion relating to whether one or more of the flags are set as flagged for the historical price goods-attribute 442, the common price goods attribute 444, and/or any other additional and/or alternative goods-attributes in sub-level 430, which may correspond to the evaluation goods-attribute 424.

In one example, the flag of the evaluation goods-attribute 424 may be set by back-end 164 (FIG. 1), for example, based on a criterion relating to an identity and/or a count of one or more of the flags, which are set as flagged for the historical price goods-attribute 442, the common price goods attribute 444, and/or any other additional and/or alternative goods-attributes in sub-level 430, which may correspond to the evaluation goods-attribute 424.

In one example, the flag of the evaluation goods-attribute 424 may be set as flagged by back-end 164 (FIG. 1), for example, based on a determination that at least one flag is set as flagged for the historical price goods-attribute 442, the common price goods attribute 444, and/or any other additional and/or alternative goods-attributes in sub-level 430, which may correspond to the evaluation goods-attribute 424.

In one example, the flag of the evaluation goods-attribute 424 may be set as flagged by back-end 164 (FIG. 1), for example, based on a determination that at least x>=1 flags are set as flagged for the historical price goods-attribute 442, the common price goods attribute 444, and/or any other additional and/or alternative goods-attributes in sub-level 430, which may correspond to the evaluation goods-attribute 424.

In one example, the flag of the evaluation goods-attribute 424 may be set as clear by back-end 164 (FIG. 1), for example, based on a determination that no more than y flags are set as flagged for the historical price goods-attribute 442, the common price goods attribute 444, and/or any other additional and/or alternative goods-attributes in sub-level 430, which may correspond to the evaluation goods-attribute 424.

In one example, the flag of the evaluation goods-attribute 424 may be set as clear by back-end 164 (FIG. 1), for example, based on a determination that no flags are set as flagged for the historical price goods-attribute 442, the common price goods attribute 444, and/or any other additional and/or alternative goods-attributes in sub-level 430, which may correspond to the evaluation goods-attribute 424.

In some demonstrative aspects, application 160 (FIG. 1), e.g., back-end 164 (FIG. 1), may be configured to compare the declared price of the goods with an expected price, which may be determined, for example, based on values of the same goods that are sold elsewhere. For example, application 160 (FIG. 1) may be configured to determine whether the declared price is logical and/or reliable.

In some demonstrative aspects, as shown in FIG. 4, sub level 430 may include a volume goods-attribute 452, a weight goods attribute 454, a defective/damaged goods attribute 456, and/or any other additional and/or alternative goods-attributes corresponding to the physical goods-attribute 424.

In some demonstrative aspects, one or more flags of the physical goods-attribute 426 may be set by back-end 164 (FIG. 1), for example, based on flags of the volume goods-attribute 452, the weight goods attribute 454, the defective/damaged goods attribute 456, and/or any other additional and/or alternative flags of goods-attributes in sub-level 430, which may correspond to the physical goods-attribute 426.

For example, a flag of the physical goods-attribute 426 may be set by back-end 164 (FIG. 1), for example, based on a determination that one or more of the flags are set as flagged for the volume goods-attribute 452, the weight goods attribute 454, the defective/damaged goods attribute 456, and/or any other additional and/or alternative flags of goods-attributes in sub-level 430, which may correspond to the physical goods-attribute 426.

In one example, the flag of the physical goods-attribute 426 may be set by back-end 164 (FIG. 1), for example, based on a criterion relating to whether one or more of the flags are set as flagged for the volume goods-attribute 452, the weight goods attribute 454, the defective/damaged goods attribute 456, and/or any other additional and/or alternative flags of goods-attributes in sub-level 430, which may correspond to the physical goods-attribute 426.

In one example, the flag of the physical goods-attribute 426 may be set by back-end 164 (FIG. 1), for example, based on a criterion relating to an identity and/or a count of one or more of the flags, which are set as flagged for the volume goods-attribute 452, the weight goods attribute 454, the defective/damaged goods attribute 456, and/or any other additional and/or alternative flags of goods-attributes in sub-level 430, which may correspond to the physical goods-attribute 426.

In one example, the flag of the physical goods-attribute 426 may be set as flagged by back-end 164 (FIG. 1), for example, based on a determination that at least one flag is set as flagged for the volume goods-attribute 452, the weight goods attribute 454, the defective/damaged goods attribute 456, and/or any other additional and/or alternative flags of goods-attributes in sub-level 430, which may correspond to the physical goods-attribute 426.

In one example, the flag of the physical goods-attribute 426 may be set as flagged by back-end 164 (FIG. 1), for example, based on a determination that at least x>=1 flags are set as flagged for the volume goods-attribute 452, the weight goods attribute 454, the defective/damaged goods attribute 456, and/or any other additional and/or alternative flags of goods-attributes in sub-level 430, which may correspond to the physical goods-attribute 426.

In one example, the flag of the physical goods-attribute 426 may be set as clear by back-end 164 (FIG. 1), for example, based on a determination that no more than y flags are set as flagged for the volume goods-attribute 452, the weight goods attribute 454, the defective/damaged goods attribute 456, and/or any other additional and/or alternative flags of goods-attributes in sub-level 430, which may correspond to the physical goods-attribute 426.

In one example, the flag of the physical goods-attribute 426 may be set as clear by back-end 164 (FIG. 1), for example, based on a determination that no flags are set as flagged for the volume goods-attribute 452, the weight goods attribute 454, the defective/damaged goods attribute 456, and/or any other additional and/or alternative flags of goods-attributes in sub-level 430, which may correspond to the physical goods-attribute 426.

In some demonstrative aspects, application 160 (FIG. 1), e.g., back-end 164 (FIG. 1), may be configured to verify whether a declared weight of the goods is logical, for example, based on an expected weight, which may be determined, for example, based on analysis of historical data from a variety of sources. According to this example, application 160 (FIG. 1) may flag the weight goods attribute 454, for example, if the declared weight is not logical.

In some demonstrative aspects, application 160 (FIG. 1), e.g., back-end 164 (FIG. 1), may be configured to analyze an imported vehicle, for example, based on a declared Vehicle Identification Number (VIN), to identify a variety of information about the type of vehicle, and the specific vehicle, e.g., a model of the vehicle, where it was manufactured, photographs, and/or damage to the specific vehicle. According to this example, application 160 (FIG. 1) may flag the defective/damaged goods attribute 456, for example, if the specific vehicle is determined to be damaged.

In some demonstrative aspects, one or more flags 415 of the goods block 412 may be set by back-end 164 (FIG. 1), for example, based on flags of the classification goods-attribute 422, the evaluation goods-attribute 424, the physical goods-attribute 426, and/or any other additional and/or alternative flags of goods-attributes in sub-level 420.

For example, a flag 415 of the goods block 412 may be set by back-end 164 (FIG. 1), for example, based on a determination that one or more of the flags are set as flagged for the classification goods-attribute 422, the evaluation goods-attribute 424, the physical goods-attribute 426, and/or any other additional and/or alternative flags of goods-attributes in sub-level 420.

In one example, the flag 415 of the goods block 412 may be set by back-end 164 (FIG. 1), for example, based on a criterion relating to whether one or more of the flags are set as flagged for the classification goods-attribute 422, the evaluation goods-attribute 424, the physical goods-attribute 426, and/or any other additional and/or alternative flags of goods-attributes in sub-level 420.

In one example, the flag 415 of the goods block 412 may be set by back-end 164 (FIG. 1), for example, based on a criterion relating to an identity and/or a count of one or more of the flags, which are set as flagged for the classification goods-attribute 422, the evaluation goods-attribute 424, the physical goods-attribute 426, and/or any other additional and/or alternative flags of goods-attributes in sub-level 420.

In one example, the flag 415 of the goods block 412 may be set as flagged by back-end 164 (FIG. 1), for example, based on a determination that at least one flag is set as flagged for the classification goods-attribute 422, the evaluation goods-attribute 424, the physical goods-attribute 426, and/or any other additional and/or alternative flags of goods-attributes in sub-level 420.

In one example, the flag 415 of the goods block 412 may be set as flagged by back-end 164 (FIG. 1), for example, based on a determination that at least x>=1 flags are set as flagged for the classification goods-attribute 422, the evaluation goods-attribute 424, the physical goods-attribute 426, and/or any other additional and/or alternative flags of goods-attributes in sub-level 420.

In one example, the flag 415 of the goods block 412 may be set as clear by back-end 164 (FIG. 1), for example, based on a determination that no more than y flags are set as flagged for the classification goods-attribute 422, the evaluation goods-attribute 424, the physical goods-attribute 426, and/or any other additional and/or alternative flags of goods-attributes in sub-level 420.

In one example, the flag 415 of the goods block 412 may be set as clear by back-end 164 (FIG. 1), for example, based on a determination that no flags are set as flagged for the classification goods-attribute 422, the evaluation goods-attribute 424, the physical goods-attribute 426, and/or any other additional and/or alternative flags of goods-attributes in sub-level 420.

For example, back-end 164 (FIG. 1) may determine that the flag for the HS code mismatch goods-attribute 432 is to be flagged, for example, based on a determination that the declared description of the goods provided in the shipment documentation does not match the description of goods with the HS code actually matches. For example, back-end 164 (FIG. 1) may determine that the flag for the classification goods-attribute 422 is to be flagged, for example, based on a determination that the flag for the HS code mismatch goods-attribute 432 is flagged. For example, back-end 164 (FIG. 1) may determine that the flag 415 for the goods block 412 is to be flagged, for example, based on a determination that the flag for the classification goods-attribute 422 is flagged.

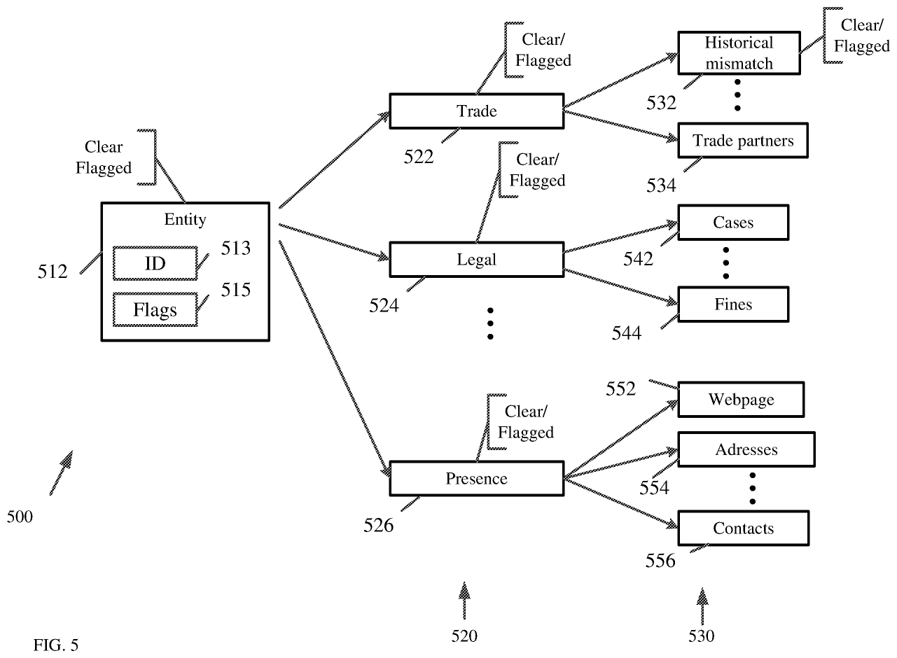

Reference is made to FIG. 5, which schematically illustrates a plurality of entity-based sub-levels to provide entity-supportive information 500 of a specific entity, in accordance with some demonstrative aspects.

In some demonstrative aspects, the entity-supportive information 500 of a particular (specific) entity in an imported shipment may be determined based on a plurality of entity-based sub-levels, e.g., as described below.

In some demonstrative aspects, application 160 (FIG. 1), e.g., back-end 164 (FIG. 1), may be configured to determine an entity-based recommendation for the particular entity, for example, based on a plurality of entity-based sub-levels, e.g., as described below.

In some demonstrative aspects, application 160 (FIG. 1), e.g., back-end 164 (FIG. 1), may be configured to determine the entity-based recommendation for the particular entity, for example, based on an entity-based sub-level 520 and/or an entity-based sub-level 530, e.g., as described below.

In some demonstrative aspects, application 160 (FIG. 1), e.g., back-end 164 (FIG. 1), may be configured to determine a first plurality of entity-based recommendations in entity-based sub-level 530, for example, based on the declared entity attributes corresponding to the particular entity and the retrieved entity-based information corresponding to the particular entity, e.g., as described below.

In some demonstrative aspects, application 160 (FIG. 1), e.g., back-end 164 (FIG. 1), may be configured to determine a second plurality of entity-based recommendations in entity-based sub-level 520, for example, based on the first plurality of entity-based recommendations in entity-based sub-level 530 and/or entity-based recommendations in one or more other entity-based sub layers, e.g., as described below.

In some demonstrative aspects, application 160 (FIG. 1), e.g., back-end 164 (FIG. 1), may be configured to determine the entity-based recommendation for the particular entity, for example, based on the second plurality of entity-based recommendations in entity-based sub-level 520 and/or entity-based recommendations in one or more other entity-based sub layers, e.g., as described below.

In some demonstrative aspects, a front-end of an application, e.g., front-end 162 (FIG. 1), may be configured to cause a GUI of the application to display and/or present some or all of the entity-supportive information 500.

In some demonstrative aspects, the front-end of the application e.g., front-end 162 (FIG. 1), may be configured to cause the GUI of the application to display and/or present some or all of the entity-supportive information 500, for example, in response to, or based on, an input from the user to request for supportive information for specific entity of an imported shipment.

In one example, front-end 162 (FIG. 1) may cause, control, and/or instruct GUI 116 (FIG. 1), to display and/or present some or all of the entity-supportive information 500 to the user, for example, based on an input from the user, for example, via GUI 116 (FIG. 1).

In some demonstrative aspects, as shown in FIG. 5, the entity-supportive information 500 may be determined, e.g., by back-end 164 (FIG. 1) and/or presented, e.g., by front-end 162 (FIG. 1), for example, according to an arranged plurality of entity-sub levels, for example, including the first sub-level 520 and the second sub-level 530.

In some demonstrative aspects, the entity-supportive information 500 may include one or more additional sub-levels, e.g., additional to sub-level 520 and the sub-level 530.

In some demonstrative aspects, as shown in FIG. 5, sub level 520 may include a first plurality of entity recommendations, e.g., arranged in a first plurality of blocks.

In some demonstrative aspects, as shown in FIG. 5, sub level 530 may include a second plurality of entity recommendations, e.g., arranged in a second plurality of blocks.

In some demonstrative aspects, the first plurality of entity recommendations in sub level 520 may be based on the second plurality of entity recommendations in sub level 530, e.g., as described below.

In some demonstrative aspects, a block, e.g., each block, of the first plurality of blocks and/or the second plurality of blocks may be displayed and/or presented to a user, e.g., in a separate window.

In some demonstrative aspects, one or more blocks of the first plurality of blocks and/or the second plurality of blocks, e.g., some or all of the blocks, may be displayed and/or presented in a same window.

In some demonstrative aspects, the entity-supportive information 500 may include an entity block 512.

In some demonstrative aspects, as shown in FIG. 5, entity block 512 may include an entity ID 513 of the specific entity.

In one example, entity ID 513 may include an entity ID of an exporter of the imported shipment, for example, in case the user requests for supportive information for the recommendation corresponding to the exporter of the imported shipment.

In another example, entity ID 513 may include an entity ID of an importer of the imported shipment, for example, in case the user requests for supportive information for the recommendation corresponding to the importer of the imported shipment.

In another example, entity ID 513 may include any other entity ID of any other entity associated with the imported shipment.

In some demonstrative aspects, as shown in FIG. 5, entity block 512 may include one or more flags 515 to flag one or more entity inspected attributes of the entity, e.g., as cleared, or as flagged.

In some demonstrative aspects, as shown in FIG. 5, sub level 520 may include a plurality of attributes, e.g., including a trade entity-attribute 522, a legal entity-attribute 524, and/or a presence entity-attribute 526.

In other aspects, sub level 520 may include any other additional and/or alternative entity-attributes.

In some demonstrative aspects, the presence entity-attribute 526 may include a description of the business and/or contact details for the entity, such as phone numbers, email addresses, social media online profiles, websites, addresses, and/or the like.

In some demonstrative aspects, the trade entity-attribute 522 may include information about the history of goods traded/shipped by the entity. For example, application 160 (FIG. 1) may extract this information from the local DB 152 (FIG. 1) including history of shipment documentations, external sources collected from DB 150 (FIG. 1), and/or the like.

In one example, the trade entity-attribute 522 may include general documents corresponding to products sold by the entity, such as product brochures. For example, application 160 (FIG. 1) may be configured to extract this general documents from history of shipment documentations, external sources collected from DB 150 (FIG. 1), and/or the like.

In some demonstrative aspects, the legal entity-attribute 524 may include various sections of information about the legal aspects of the entity.

In one example, the legal entity-attribute 524 may include a company's registration number, a status of the company, e.g., active or inactive (dissolved), and/or the like.

In some demonstrative aspects, as shown in FIG. 5, sub level 530 may include a plurality of attributes, e.g., including a historical mismatch entity-attribute 532, a trade pattern entity-attribute 534, and/or any other additional and/or alternative entity-attributes, which correspond to the trade entity-attribute 522.

In some demonstrative aspects, a flag of the trade entity-attribute 522 may be set by back-end 164 (FIG. 1), for example, based on flags of the historical mismatch entity-attribute 532, the trade pattern entity-attribute 535, and/or any other additional and/or alternative entity-attributes in sub-level 530, which correspond to the trade entity-attribute 522.

For example, the flag of the trade entity-attribute 522 may be set by back-end 164 (FIG. 1), for example, based on a determination that one or more of the flags are set as flagged for the historical mismatch entity-attribute 532, the trade pattern entity-attribute 535, and/or any other additional and/or alternative entity-attributes in sub-level 530, which correspond to the trade entity-attribute 522.

In one example, the flag of the trade entity-attribute 522 may be set by back-end 164 (FIG. 1), for example, based on a criterion relating to whether one or more of the flags are set as flagged for the historical mismatch entity-attribute 532, the trade pattern entity-attribute 535, and/or any other additional and/or alternative entity-attributes in sub-level 530, which correspond to the trade entity-attribute 522.

In one example, the flag of the trade entity-attribute 522 may be set by back-end 164 (FIG. 1), for example, based on a criterion relating to an identity and/or a count of one or more of the flags, which are set as flagged for the historical mismatch entity-attribute 532, the trade pattern entity-attribute 535, and/or any other additional and/or alternative entity-attributes in sub-level 530, which correspond to the trade entity-attribute 522.

In one example, the flag of the trade entity-attribute 522 may be set as flagged by back-end 164 (FIG. 1), for example, based on a determination that at least one flag is set as flagged for the historical mismatch entity-attribute 532, the trade pattern entity-attribute 535, and/or any other additional and/or alternative entity-attributes in sub-level 530, which correspond to the trade entity-attribute 522.

In one example, the flag of the trade entity-attribute 522 may be set as flagged by back-end 164 (FIG. 1), for example, based on a determination that at least x>=1 flags are set as flagged for the historical mismatch entity-attribute 532, the trade pattern entity-attribute 535, and/or any other additional and/or alternative entity-attributes in sub-level 530, which correspond to the trade entity-attribute 522.

In one example, the flag of the trade entity-attribute 522 may be set as clear by back-end 164 (FIG. 1), for example, based on a determination that no more than y flags are set as flagged for the historical mismatch entity-attribute 532, the trade pattern entity-attribute 535, and/or any other additional and/or alternative entity-attributes in sub-level 530, which correspond to the trade entity-attribute 522.

In one example, the flag of the trade entity-attribute 522 may be set as clear by back-end 164 (FIG. 1), for example, based on a determination that no flags are set as flagged for the historical mismatch entity-attribute 532, the trade pattern entity-attribute 535, and/or any other additional and/or alternative entity-attributes in sub-level 530, which correspond to the trade entity-attribute 522.

In some demonstrative aspects, application 160 (FIG. 1), e.g., back-end 164 (FIG. 1), may be configured to determine a percentage of times that the entity used the description of goods together with the same HS codes. For example, a reliable company may be expected to always use the same HS code for the same description of goods.

In some demonstrative aspects, application 160 (FIG. 1), e.g., back-end 164 (FIG. 1), may be configured to determine whether the entity uses different HS codes for a same product.

In some demonstrative aspects, application 160 (FIG. 1), e.g., back-end 164 (FIG. 1), may be configured to flag the historical mismatch entity-attribute 532, for example, based on the analysis of the declared entity attributes and the retrieved entity-based information from database 150 (FIG. 1).

In one example, application 160 (FIG. 1) may be configured to analyze trade partners with which the organization has worked so far, e.g., shipping companies, or the like.

According to this example, application 160 (FIG. 1) may be configured to flag the trade pattern entity-attribute 535, for example, when one or more issues are raised for the trade partners.

In some demonstrative aspects, as shown in FIG. 5, sub level 530 may include a plurality of attributes, e.g., including a cases entity-attribute 542, a fines entity attribute 544, and/or any other additional and/or alternative entity-attributes corresponding to the legal entity-attribute 524.

In some demonstrative aspects, a flag of the legal entity-attribute 524 may be set by back-end 164 (FIG. 1), for example, based on flags of the cases entity-attribute 542, the fines entity attribute 544, and/or any other additional and/or alternative entity-attributes in sub-level 530, which corresponds to the legal entity-attribute 524.

For example, the flag of the legal entity-attribute 524 may be set by back-end 164 (FIG. 1), for example, based on a determination that one or more of the flags are set as flagged for the cases entity-attribute 542, the fines entity attribute 544, and/or any other additional and/or alternative entity-attributes in sub-level 530, which corresponds to the legal entity-attribute 524.

In one example, the flag of the legal entity-attribute 524 may be set by back-end 164 (FIG. 1), for example, based on a criterion relating to whether one or more of the flags are set as flagged for the cases entity-attribute 542, the fines entity attribute 544, and/or any other additional and/or alternative entity-attributes in sub-level 530, which corresponds to the legal entity-attribute 524.

In one example, the flag of the legal entity-attribute 524 may be set by back-end 164 (FIG. 1), for example, based on a criterion relating to an identity and/or a count of one or more of the flags, which are set as flagged for the cases entity-attribute 542, the fines entity attribute 544, and/or any other additional and/or alternative entity-attributes in sub-level 530, which corresponds to the legal entity-attribute 524.

In one example, the flag of the legal entity-attribute 524 may be set as flagged by back-end 164 (FIG. 1), for example, based on a determination that at least one flag is set as flagged for the cases entity-attribute 542, the fines entity attribute 544, and/or any other additional and/or alternative entity-attributes in sub-level 530, which corresponds to the legal entity-attribute 524.

In one example, the flag of the legal entity-attribute 524 may be set as flagged by back-end 164 (FIG. 1), for example, based on a determination that at least x>=1 flags are set as flagged for the cases entity-attribute 542, the fines entity attribute 544, and/or any other additional and/or alternative entity-attributes in sub-level 530, which corresponds to the legal entity-attribute 524.

In one example, the flag of the legal entity-attribute 524 may be set as clear by back-end 164 (FIG. 1), for example, based on a determination that no more than y flags are set as flagged for the cases entity-attribute 542, the fines entity attribute 544, and/or any other additional and/or alternative entity-attributes in sub-level 530, which corresponds to the legal entity-attribute 524.

In one example, the flag of the legal entity-attribute 524 may be set as clear by back-end 164 (FIG. 1), for example, based on a determination that no flags are set as flagged for the cases entity-attribute 542, the fines entity attribute 544, and/or any other additional and/or alternative entity-attributes in sub-level 530, which corresponds to the legal entity-attribute 524.

In some demonstrative aspects, as shown in FIG. 5, sub level 530 may include a plurality of attributes, e.g., including a webpage entity-attribute 552, an addresses entity attribute 554, a contacts entity attribute 556, and/or any other additional and/or alternative entity-attributes corresponding to the presence entity-attribute 524.

In some demonstrative aspects, one or more flags of the presence entity-attribute 526 may be set by back-end 164 (FIG. 1), for example, based on flags of the webpage entity-attribute 552, the addresses entity attribute 554, the contacts entity attribute 556, and/or any other additional and/or alternative flags of entity-attributes in sub-level 530, which corresponds to the presence entity-attribute 526.

For example, a flag of the presence entity-attribute 526 may be set by back-end 164 (FIG. 1), for example, based on a determination that one or more of the flags are set as flagged for the webpage entity-attribute 552, the addresses entity attribute 554, the contacts entity attribute 556, and/or any other additional and/or alternative flags of entity-attributes in sub-level 530, which corresponds to the presence entity-attribute 526.

In one example, the flag of the presence entity-attribute 526 may be set by back-end 164 (FIG. 1), for example, based on a criterion relating to whether one or more of the flags are set as flagged for the webpage entity-attribute 552, the addresses entity attribute 554, the contacts entity attribute 556, and/or any other additional and/or alternative flags of entity-attributes in sub-level 530, which corresponds to the presence entity-attribute 526.

In one example, the flag of the presence entity-attribute 526 may be set by back-end 164 (FIG. 1), for example, based on a criterion relating to an identity and/or a count of one or more of the flags, which are set as flagged for the webpage entity-attribute 552, the addresses entity attribute 554, the contacts entity attribute 556, and/or any other additional and/or alternative flags of entity-attributes in sub-level 530, which corresponds to the presence entity-attribute 526.

In one example, the flag of the presence entity-attribute 526 may be set as flagged by back-end 164 (FIG. 1), for example, based on a determination that at least one flag is set as flagged for the webpage entity-attribute 552, the addresses entity attribute 554, the contacts entity attribute 556, and/or any other additional and/or alternative flags of entity-attributes in sub-level 530, which corresponds to the presence entity-attribute 526.

In one example, the flag of the presence entity-attribute 526 may be set as flagged by back-end 164 (FIG. 1), for example, based on a determination that at least x>=1 flags are set as flagged for the webpage entity-attribute 552, the addresses entity attribute 554, the contacts entity attribute 556, and/or any other additional and/or alternative flags of entity-attributes in sub-level 530, which corresponds to the presence entity-attribute 526.

In one example, the flag of the presence entity-attribute 526 may be set as clear by back-end 164 (FIG. 1), for example, based on a determination that no more than y flags are set as flagged for the webpage entity-attribute 552, the addresses entity attribute 554, the contacts entity attribute 556, and/or any other additional and/or alternative flags of entity-attributes in sub-level 530, which corresponds to the presence entity-attribute 526.

In one example, the flag of the presence entity-attribute 526 may be set as clear by back-end 164 (FIG. 1), for example, based on a determination that no flags are set as flagged for the webpage entity-attribute 552, the addresses entity attribute 554, the contacts entity attribute 556, and/or any other additional and/or alternative flags of entity-attributes in sub-level 530, which corresponds to the presence entity-attribute 526.

In some demonstrative aspects, one or more flags 515 of the entity block 512 may be set by back-end 164 (FIG. 1), for example, based on flags of the trade entity-attribute 522, the legal entity-attribute 524, presence entity-attribute 526, and/or any other additional and/or alternative flags of goods-attributes in sub-level 520.

For example, a flag 515 of the entity block 512 may be set by back-end 164 (FIG. 1), for example, based on a determination that one or more of the flags are set as flagged for the trade entity-attribute 522, the legal entity-attribute 524, presence entity-attribute 526, and/or any other additional and/or alternative flags of goods-attributes in sub-level 520.

In one example, the flag 515 of the entity block 512 may be set by back-end 164 (FIG. 1), for example, based on a criterion relating to whether one or more of the flags are set as flagged for the trade entity-attribute 522, the legal entity-attribute 524, presence entity-attribute 526, and/or any other additional and/or alternative flags of goods-attributes in sub-level 520.

In one example, the flag 515 of the entity block 512 may be set by back-end 164 (FIG. 1), for example, based on a criterion relating to an identity and/or a count of one or more of the flags, which are set as flagged for the trade entity-attribute 522, the legal entity-attribute 524, presence entity-attribute 526, and/or any other additional and/or alternative flags of goods-attributes in sub-level 520.

In one example, the flag 515 of the entity block 512 may be set as flagged by back-end 164 (FIG. 1), for example, based on a determination that at least one flag is set as flagged for the trade entity-attribute 522, the legal entity-attribute 524, presence entity-attribute 526, and/or any other additional and/or alternative flags of goods-attributes in sub-level 520.

In one example, the flag 515 of the entity block 512 may be set as flagged by back-end 164 (FIG. 1), for example, based on a determination that at least x>=1 flags are set as flagged for the trade entity-attribute 522, the legal entity-attribute 524, presence entity-attribute 526, and/or any other additional and/or alternative flags of goods-attributes in sub-level 520.

In one example, the flag 515 of the entity block 512 may be set as clear by back-end 164 (FIG. 1), for example, based on a determination that no more than y flags are set as flagged for the trade entity-attribute 522, the legal entity-attribute 524, presence entity-attribute 526, and/or any other additional and/or alternative flags of goods-attributes in sub-level 520.

In one example, the flag 515 of the entity block 512 may be set as clear by back-end 164 (FIG. 1), for example, based on a determination that no flags are set as flagged for the trade entity-attribute 522, the legal entity-attribute 524, presence entity-attribute 526, and/or any other additional and/or alternative flags of goods-attributes in sub-level 520.

For example, back-end 164 (FIG. 1) may determine that the flag for the historical mismatch entity-attribute 532 is to be flagged, for example, based on a determination that a count of historical code mismatches for the entity is greater than a predefined threshold. For example, back-end 164 (FIG. 1) may determine that the flag for the trade entity-attribute 522 is to be flagged, for example, based on a determination that the flag for the historical mismatch entity-attribute 532 is flagged. For example, back-end 164 (FIG. 1) may determine that the flag 515 for the entity block 512 is to be flagged, for example, based on a determination that the flag for the trade entity-attribute 522 is flagged.

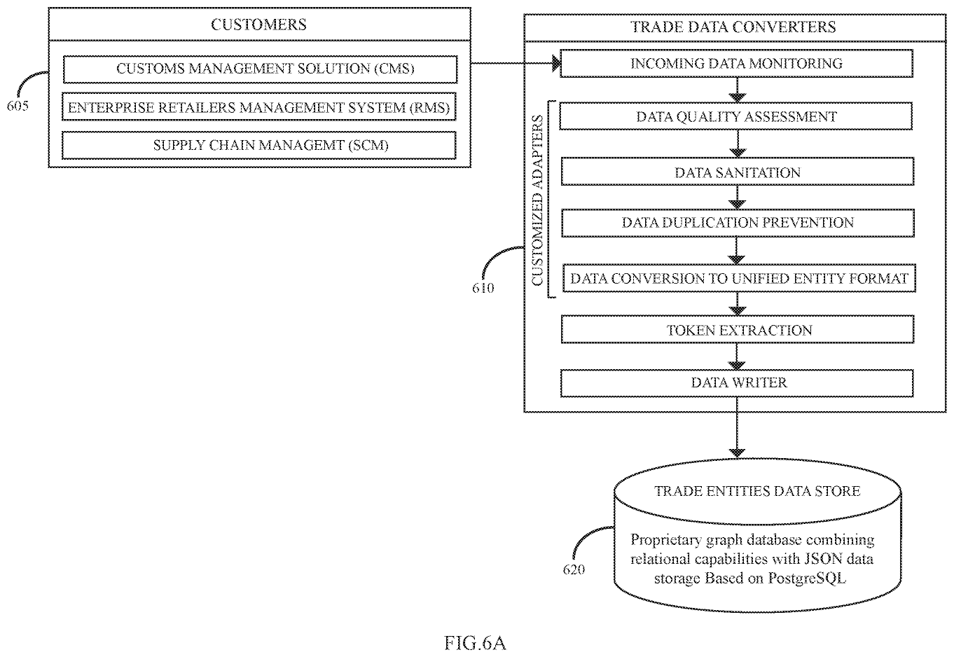

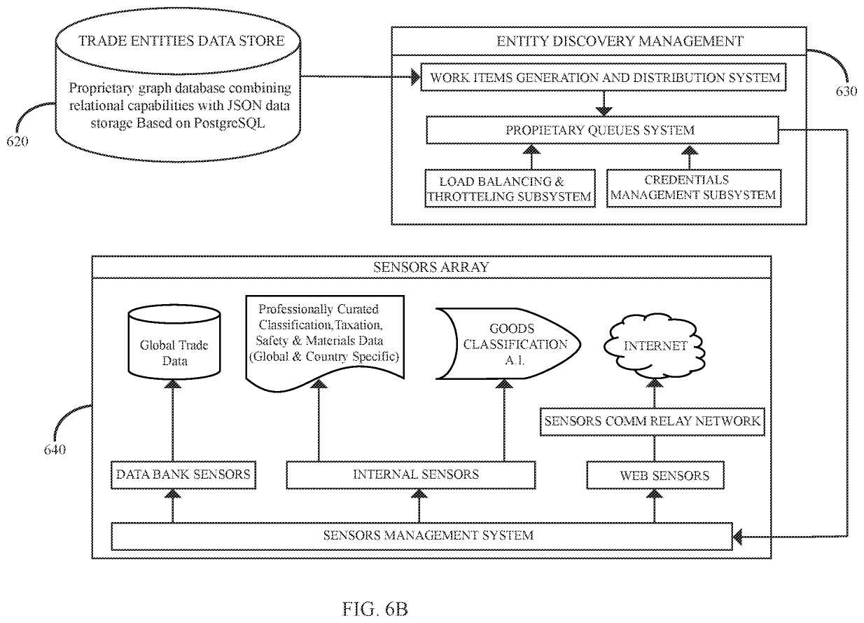

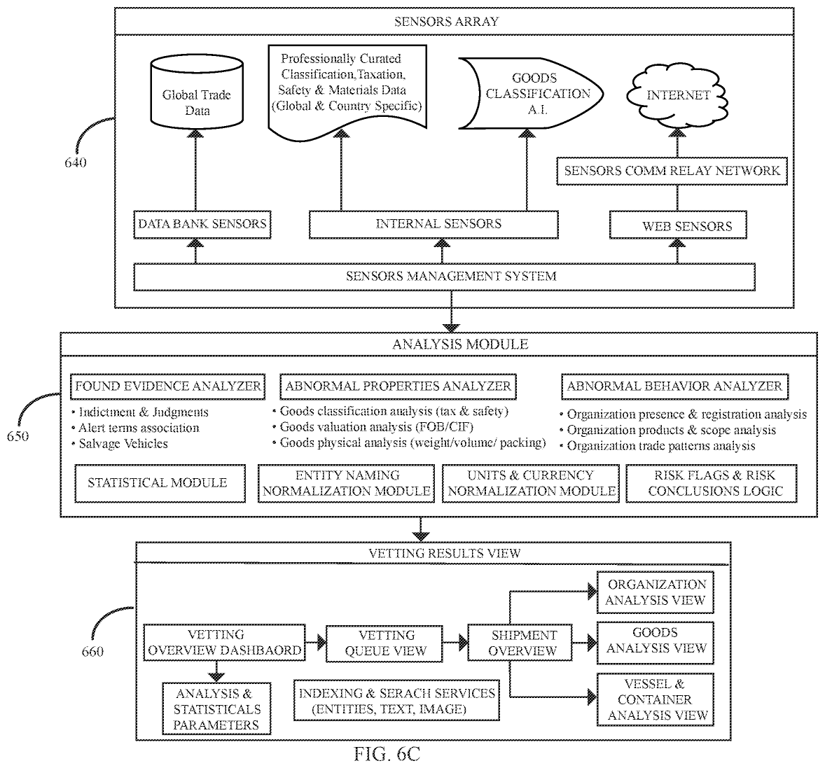

Reference is made to FIGS. 6A, 6B and 6C, which schematically illustrate a trade analysis system 600, in accordance with some demonstrative aspects.

In some demonstrative aspects, one or more elements of system 100 (FIG. 1), e.g., application 160 (FIG. 1), computing device 102 (FIG. 1), and/or server 170 (FIG. 1), may include one or more elements, modules, systems, and/or blocks of trade analysis system 600, and/or may be configured to perform one or more operations of trade analysis system 600.

In some demonstrative aspects, trade analysis system 600 may be configured according to an architecture including a plurality of modules, which may be configured to provide a technical solution to allow a conversion of supply chain and/or shipment documentation from a wide array of different customers and/or service providers to a unified format for processing into shipment, screening, classification, and/or inspection.

In some demonstrative aspects, trade analysis system 600 may be configured according to an architecture including a plurality of modules, which may be configured to provide a technical solution to support different data storage, formats, and/or quality of data.

In some demonstrative aspects, trade analysis system 600 may be configured according to an architecture including a plurality of modules, which may be configured to provide a technical solution to support a high throughput of incoming data.

In some demonstrative aspects, as shown in FIG. 6, trade analysis system 600 may include a customers module 605 including one or more customers submodules, for example, to manage one or more customers of the trade analysis system 600.

In some demonstrative aspects, as shown in FIG. 6, trade analysis system 600 may include a data conversion module 610.

In some demonstrative aspects, as shown in FIG. 6, data conversion module 610 may include an incoming data monitoring sub-module, for example, configured to constantly monitor an endpoint on the customer data repository, e.g., Database, files, APIs, to notify the system when new data is available, and/or to retrieve the data to be processed.

In some demonstrative aspects, as shown in FIG. 6, data conversion module 610 may include a data quality assessment sub-module configured to scan different input fields and use a set of dynamic rules to assess the ability of the system to use the data to extract useful analysis, for example, as data received may vary in quality.

In some demonstrative aspects, as shown in FIG. 6, data conversion module 610 may include a data sanitation submodule configured to use predefined lists and/or heuristics to remove problematic data parts and/or to keep meaningful data, e.g., as the data received may contain noise that interferes with the analysis. For example, data parts that are recognized as belonging to a specific ontology, e.g., HS codes, packaging types, and/or the like, may can be checked against a dataset to verify their validity.

In some demonstrative aspects, as shown in FIG. 6, data conversion module 610 may include a data duplication prevention sub-module configured to remove duplicated data, for example, to prevent unnecessary data processing and/or to provide concise and reliable results, e.g., as the data received may often contain repetitions due to multiple supply chain entities reporting the same data to the customer at different stages.

In some demonstrative aspects, as shown in FIG. 6, data conversion module 610 may include a data conversion to unified entity format sub-module configured to normalize textual data using string analysis heuristics and/or the numerical data, e.g., weights, prices, and/or the like, for example, to convert the textual data into standard “per unit” measurements to be properly incorporated into system analysis in later stages. For example, the data processed by in trade analysis system 600 may be first converted to a unified form compatible with system modules, and may be normalized, for example, to allow data processing and/or data storage on the customer side in a variety of formats and/or structures.

In some demonstrative aspects, as shown in FIG. 6, data conversion module 610 may include a token extraction sub-module configured to detect and/or extract data parts from data fields, e.g., each of the data fields that can be used as a separated data point, for example, in opposed to the data sanitation submodule, in which some data parts may be removed. For example, company name may be fused together with data such as phone numbers or addresses. For example, by extracting and separating such data, the trade analysis system 600 may further sanitize the company name and/or extract valuable data that can be used later on to further the analysis.

In some demonstrative aspects, as shown in FIG. 6, data conversion module 610 may include a data writer sub-module including a recursive data writing submodule configured to write large amounts of data, e.g., hundreds of entities per second, into data store, for example, while maintaining efficient computation and memory limits. For example, the recursive nature of the data writer may allow traversing an imported unified entities graph while searching for existing identical entities in the data store to prevent duplications and/or handle the required throughput.

In some demonstrative aspects, as shown in FIG. 6, trade analysis system 600 may include a trade entities data store 620, which may be configured, for example, to support flexibility in data retention and/or in retrieval. For example, the data store 620 may include a unique combination of a graph data storage layer written over relational DB infrastructure, combining fixed and/or dynamic data fields. For example, the data store 620 may store the entities while providing polymorphism access for maximum flexibility while querying heterogeneous entities.

In some demonstrative aspects, as shown in FIG. 6, trade analysis system 600 may include an entity discovery management module 630.

In some demonstrative aspects, as shown in FIG. 6, entity discovery management module 630 may include a work items generation and distribution system. For example, an entity, e.g., every entity, may undergo multiple discovery processes during its lifetime. For example, using a set of rules and heuristics, these discovery processes may be divided to multiple sub-tasks, e.g., each targeted at a specific data source with its unique inputs and outputs, tracking characteristics, and logic.

In some demonstrative aspects, as shown in FIG. 6, entity discovery management module 630 may include a queues system.

In some demonstrative aspects, as shown in FIG. 6, the queues system may include a load balancing and throttling subsystem configured to create a large number of subtasks, e.g., thousands of subtasks, that may be managed, for example, to prevent system overload and/or data source overload. For example, the load balancing and throttling subsystem may be configured to decide on an appropriate rate and/or distribution of the subtasks to the different resources, for example, through a series of rules and historical run statistics.

In some demonstrative aspects, as shown in FIG. 6, the queues system may include a credentials management subsystem, which may be configured to manage the required information to facilitate connections to data sources, for example, in case every data source may require a different access method and/or credentials.

In some demonstrative aspects, as shown in FIG. 6, trade analysis system 600 may include a sensors array module 640.

In some demonstrative aspects, as shown in FIG. 6, sensors array module 640 may include a sensors management subsystem configured to pull the subtasks from the queue system and manage the execution of every subtask on the appropriate resource. For example, once a subtask is complete, the sensors management subsystem may report the outcome back to the queue system along with a status (success/error) and/or may perform clean-up operations.

In some demonstrative aspects, as shown in FIG. 6, sensors array module 640 may include data bank sensors configured to efficiently and/or accurately search, retrieve and/or aggregate data from historical trade data including, for example, hundreds of millions of past trade records.

In some demonstrative aspects, as shown in FIG. 6, sensors array module 640 may include web sensors configured to enable collection of relevant data that span geographies, repository types, knowledge domains, and/or entity types, for example, to support analysis operations of trade analysis system 600 based on an ability to retrieve a massive amount of data from the web in a quick and/or efficient manner.

In some demonstrative aspects, as shown in FIG. 6, sensors array module 640 may include internal sensors configured to handle frequent update of lists including, for example, professionally curated lists of knowledge, in domains such as: taxations, medicine, pesticides, dual-use materials, hazardous materials, controlled substances and the search and retrieval of information from these lists.

In some demonstrative aspects, as shown in FIG. 6, trade analysis system 600 may include an analysis module 650.

In some demonstrative aspects, analysis module 650 may be configured to incorporate all knowledge gathered on different entities during discovery processes, and/or to analyze the information, for example, to produce vetting conclusion related either to revenue, safety, and/or security, e.g., as described above.

In some demonstrative aspects, as shown in FIG. 6, analysis module 650 may include one or more analyzers, e.g., as described below.

In some demonstrative aspects, as shown in FIG. 6, analysis module 650 may include a found evidence analyzer configured to go over data retrieved during the discovery process, to flag and/or categorize indicative evidence, for example, indictment, judgments, alerted terms, specialized conditions such as salvaged vehicles information, and/or the like.

In some demonstrative aspects, as shown in FIG. 6, analysis module 650 may include an abnormal properties analyzer configured to find abnormalities with respect to a set of properties that are common to an entity, and/or to statistically analyze and flag these abnormalities.

In one example, the abnormal properties analyzer may be configured to detect abnormality with respect to expected range of weight per unit, price per unit, and/or packing types, of specific goods.

In another example, the abnormal properties analyzer may be configured to detect abnormality with respect to goods prices, which may be compared, for example, against a wide range of external pricing data to find under/over valuation cases.

In another example, the abnormal properties analyzer may be configured to detect abnormality with respect to the goods description, which may be analyzed, for example, to identify infrequent usage of keywords, thus marking erroneous or suspicious declarations.

In another example, the abnormal properties analyzer may be configured to detect abnormality with respect to the goods description, which may be analyzed, for example, against the declared goods classification, for example, to find taxation discrepancies.

In some demonstrative aspects, as shown in FIG. 6, analysis module 650 may include an abnormal behavior analyzer configured to scan and/or detect patterns in historical data of entities (such as organizations and vessels), and/or to compare the historical behavior against the current behavior of the relevant entity. For example, in case of abnormal change in behavior, a flag may be raised, e.g., as described above.

In other aspects, analysis module 650 may include any other additional and/or alternative analyzer.

In some demonstrative aspects, as shown in FIG. 6, analysis module 650 may include one or more analysis supporting submodules configured to provide standard deviation and/or outliers removal functionality, for example, to support the analyzers with an array of statistical and/or textual analysis methods.

In some demonstrative aspects, as shown in FIG. 6, analysis module 650 may include an entity naming submodule configured to provide normalization of organization names and/or textual similarity comparison.

In some demonstrative aspects, as shown in FIG. 6, analysis module 650 may include a units and currency submodule configured to provide normalization of pricing data.

In some demonstrative aspects, as shown in FIG. 6, analysis module 650 may include a risk conclusions submodule configured to iterate over risk flags raised by the different analysis types. For example, through a set of weighted rules most critical shipment vetting conclusions may be decided, for example, in the two verticals, e.g., revenue or safety and security.

In other aspects, analysis module 650 may include any other or additional supporting submodules.

In some demonstrative aspects, as shown in FIG. 6, trade analysis system 600 may include a vetting results view module 660.

In some demonstrative aspects, vetting results view module 660 may include a graphical user interface configured to display one or more, e.g., every or almost every, shipment's vetting results, for example, with an option to drill down into one or more, e.g., every, shipment entity type, and/or view the reasoning behind the raised risk conclusions and flags, e.g., as described above.

In some demonstrative aspects, vetting results view module 660 may be configured to enable a customer to customize the vetting process, for example, to fit the organization's specific needs and/or concerns.

In some demonstrative aspects, vetting results view module 660 may be configured to enable the customer to customize the vetting process, for example, by adjusting analysis thresholds and/or customizing lists of indicative signs, which may allow the customer to receive only the alerts the customer requires.

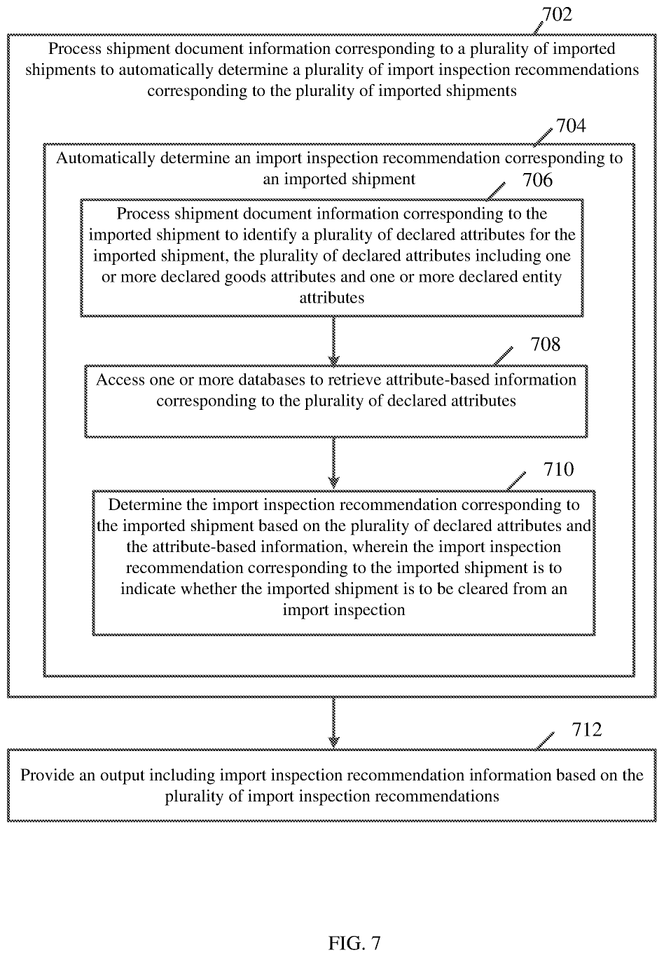

Reference is made to FIG. 7, which schematically illustrates a method of providing shipment inspection recommendations, in accordance with some demonstrative aspects. For example, one or more of the operations of the method of FIG. 7 may be performed by one or more elements of a system, e.g., system 100 (FIG. 1), for example, a computing device, e.g., computing device 102 (FIG. 1), a server, e.g., server 170 (FIG. 1), and/or an application, e.g., application 160 (FIG. 1).

As indicated at block 702, the method may include processing shipment document information corresponding to a plurality of imported shipments to automatically determine a plurality of import inspection recommendations corresponding to the plurality of imported shipments. For example, application 160 (FIG. 1) may process the shipment document information 165 (FIG. 1) corresponding to the plurality of imported shipments to automatically determine the plurality of import inspection recommendations 167 (FIG. 1) corresponding to the plurality of imported shipments, e.g., as described above.

As indicated at block 704, processing the shipment document information to automatically determine the plurality of import inspection recommendations may include automatically determining an import inspection recommendation corresponding to an imported shipment. For example, application 160 (FIG. 1) may automatically determine the import inspection recommendation 167 (FIG. 1) corresponding to the imported shipment, e.g., as described above.

As indicated at block 706, automatically determining the import inspection recommendation corresponding to the imported shipment may include processing shipment document information corresponding to the imported shipment to identify a plurality of declared attributes for the imported shipment, the plurality of declared attributes including one or more declared goods attributes and one or more declared entity attributes. For example, application 160 (FIG. 1) may process the shipment document information 165 (FIG. 1) corresponding to the imported shipment to identify the plurality of declared attributes for the imported shipment including the one or more declared goods attributes and the one or more declared entity attributes, e.g., as described above.

As indicated at block 708, automatically determining the import inspection recommendation corresponding to the imported shipment may include accessing one or more databases to retrieve attribute-based information corresponding to the plurality of declared attributes. For example, application 160 (FIG. 1) may access the one or more databases 150 (FIG. 1) to retrieve the attribute-based information corresponding to the plurality of declared attributes, e.g., as described above.

As indicated at block 710, automatically determining the import inspection recommendation corresponding to the imported shipment may include determining the import inspection recommendation corresponding to the imported shipment based on the plurality of declared attributes and the attribute-based information. For example, the import inspection recommendation corresponding to the imported shipment may indicate whether the imported shipment is to be cleared from an import inspection. For example, application 160 (FIG. 1) may determine the import inspection recommendation corresponding to the imported shipment based on the plurality of declared attributes and the attribute-based information, e.g., as described above.

As indicated at block 712, the method may include providing an output including import inspection recommendation information based on the plurality of import inspection recommendations. For example, application 160 (FIG. 1) may provide the output, e.g., via GUI 116 (FIG. 1) including the import inspection recommendation information 167 (FIG. 1) based on the plurality of import inspection recommendations, e.g., as described above.

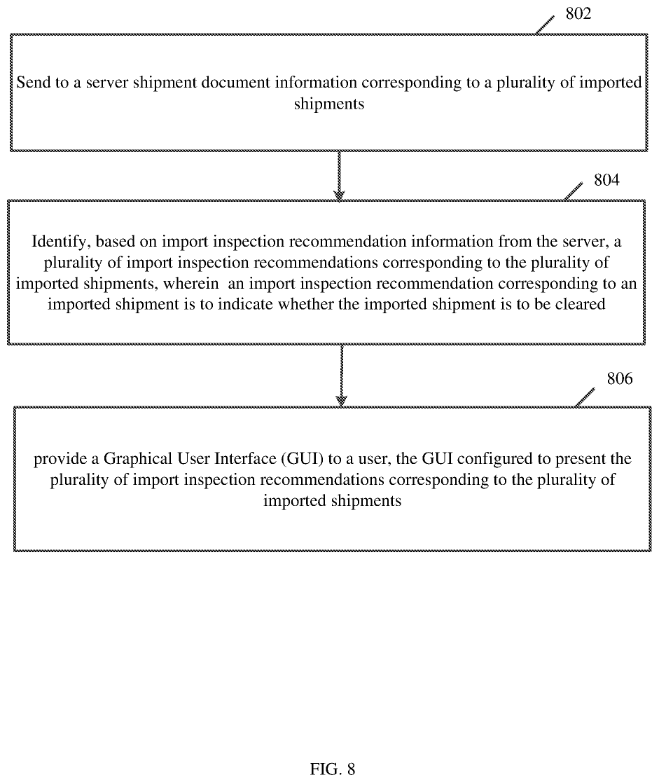

Reference is made to FIG. 8, which schematically illustrates a method of providing shipment inspection recommendations, in accordance with some demonstrative aspects. For example, one or more of the operations of the method of FIG. 8 may be performed by one or more elements of a system, e.g., system 100 (FIG. 1), for example, a computing device, e.g., computing device 102 (FIG. 1), a server, e.g., server 170 (FIG. 1), an application, e.g., application 160 (FIG. 1), and/or a front-end, e.g., front-end 162 (FIG. 1).

As indicated at block 802, the method may include sending to a server shipment document information corresponding to a plurality of imported shipments. For example, front-end 162 (FIG. 1) may send to server 170 (FIG. 1) the shipment document information 165 (FIG. 1) corresponding to the plurality of imported shipments, e.g., as described above.

As indicated at block 804, the method may include identifying, based on import inspection recommendation information from the server, a plurality of import inspection recommendations corresponding to the plurality of imported shipments. For example, an import inspection recommendation corresponding to an imported shipment may indicate whether the imported shipment is to be cleared. For example, front-end 162 (FIG. 1) may identify, based on the import inspection recommendation information 167 (FIG. 1) from the server 170 (FIG. 1), the plurality of import inspection recommendations corresponding to the plurality of imported shipments, e.g., as described above.

As indicated at block 806, the method may include providing a GUI to a user, the GUI configured to present the plurality of import inspection recommendations corresponding to the plurality of imported shipments. For example, front-end 162 (FIG. 1) may provide via GUI 116 (FIG. 1) the GUI to the user to present the plurality of import inspection recommendations corresponding to the plurality of imported shipments, e.g., as described above.

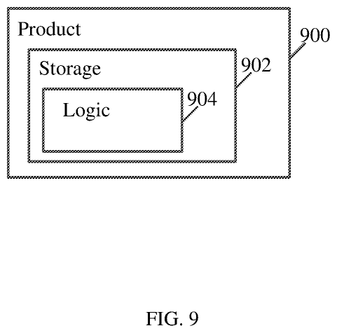

Reference is made to FIG. 9, which schematically illustrates a product of manufacture 900, in accordance with some demonstrative aspects. Product 900 may include one or more tangible computer-readable non-transitory storage media 902, which may include computer-executable instructions, e.g., implemented by logic 904, operable to, when executed by at least one computer processor, enable the at least one computer processor to implement one or more operations of computing device 102 (FIG. 1), server 170 (FIG. 1), and/or application 160 (FIG. 1), to perform one or more operations, and/or to perform, trigger and/or implement one or more operations, communications and/or functionalities according to one or more of the FIGS. 1-8, and/or one or more operations described herein. The phrase “non-transitory machine-readable medium” is directed to include all computer-readable media, with the sole exception being a transitory propagating signal.

In some demonstrative aspects, product 900 and/or machine readable storage media 902 may include one or more types of computer-readable storage media capable of storing data, including volatile memory, non-volatile memory, removable or non-removable memory, erasable or non-erasable memory, writeable or re-writeable memory, and the like. For example, machine readable storage media 902 may include, RAM, DRAM, Double-Data-Rate DRAM (DDR-DRAM), SDRAM, static RAM (SRAM), ROM, programmable ROM (PROM), erasable programmable ROM (EPROM), electrically erasable programmable ROM (EEPROM), flash memory (e.g., NOR or NAND flash memory), content addressable memory (CAM), polymer memory, phase-change memory, ferroelectric memory, silicon-oxide-nitride-oxide-silicon (SONOS) memory, a hard drive, an optical disk, a magnetic disk, and the like. The computer-readable storage media may include any suitable media involved with downloading or transferring a computer program from a remote computer to a requesting computer carried by data signals embodied in a carrier wave or other propagation medium through a communication link, e.g., a modem, radio or network connection.

In some demonstrative aspects, logic 904 may include instructions, data, and/or code, which, if executed by a machine, may cause the machine to perform a method, process and/or operations as described herein. The machine may include, for example, any suitable processing platform, computing platform, computing device, processing device, computing system, processing system, computer, processor, or the like, and may be implemented using any suitable combination of hardware, software, firmware, and the like.

In some demonstrative aspects, logic 904 may include, or may be implemented as, software, a software module, an application, a program, a subroutine, instructions, an instruction set, computing code, words, values, symbols, and the like. The instructions may include any suitable type of code, such as source code, compiled code, interpreted code, executable code, static code, dynamic code, and the like. The instructions may be implemented according to a predefined computer language, manner or syntax, for instructing a processor to perform a certain function. The instructions may be implemented using any suitable high-level, low-level, object-oriented, visual, compiled and/or interpreted programming language, machine code, and the like.

### Examples

The following examples pertain to further aspects.

Example 1 includes a product comprising one or more tangible computer-readable non-transitory storage media comprising instructions operable to, when executed by at least one processor, enable the at least one processor to cause a computing system to process shipment document information corresponding to a plurality of imported shipments to automatically determine a plurality of import inspection recommendations corresponding to the plurality of imported shipments, wherein automatically determining the plurality of import inspection recommendations comprises automatically determining an import inspection recommendation corresponding to an imported shipment by processing shipment document information corresponding to the imported shipment to identify a plurality of declared attributes for the imported shipment, the plurality of declared attributes comprising one or more declared goods attributes and one or more declared entity attributes; accessing one or more databases to retrieve attribute-based information corresponding to the plurality of declared attributes; and determining the import inspection recommendation corresponding to the imported shipment based on the plurality of declared attributes and the attribute-based information, wherein the import inspection recommendation corresponding to the imported shipment is to indicate whether the imported shipment is to be cleared from an import inspection; and provide an output comprising import inspection recommendation information based on the plurality of import inspection recommendations.

Example 2 includes the subject matter of Example 1, and optionally, wherein the attribute-based information comprises goods-based information corresponding to the one or more declared goods attributes, wherein determining the import inspection recommendation corresponding to the imported shipment comprises determining one or more expected goods-attributes based on the goods-based information, and determining the import inspection recommendation corresponding to the imported shipment based on a comparison between the expected goods-attributes and the declared goods attributes.

Example 3 includes the subject matter of Example 1 or 2, and optionally, wherein the attribute-based information comprises entity-based information corresponding to the one or more declared entity attributes, wherein determining the import inspection recommendation corresponding to the imported shipment comprises determining one or more entity-reliability indicators corresponding to the one or more declared entity attributes, and determining the import inspection recommendation corresponding to the imported shipment based on the one or more entity-reliability indicators.

Example 4 includes the subject matter of any one of Examples 1-3, and optionally, wherein automatically determining the import inspection recommendation corresponding to the imported shipment comprises retrieving the attribute-based information comprising goods-based information corresponding to the one or more declared goods attributes, and entity-based information corresponding to the one or more declared entity attributes; determining a goods-based recommendation based on the declared goods attributes and the goods-based information; determining an entity-based recommendation based on the declared entity attributes and the entity-based information; and determining the import inspection recommendation corresponding to the imported shipment based on the goods-based recommendation and the entity-based recommendation.

Example 5 includes the subject matter of Example 4, and optionally, wherein determining the goods-based recommendation comprises determining a plurality of goods-based sub-levels comprising at least a first goods-based sub-level and a second goods-based sub-level, wherein the first goods-based sub-level comprises a first plurality of goods-based recommendations based on the goods-based information, wherein the second goods-based sub-level comprises a second plurality of goods-based recommendations based on the first plurality of goods-based recommendations; and determining the goods-based recommendation based on the second plurality of goods-based recommendations.

Example 6 includes the subject matter of Example 5, and optionally, wherein determining the plurality of goods-based sub-levels comprises determining at least a third goods-based sub-level comprising a third plurality of goods-based recommendations based on the first plurality of goods-based recommendations, wherein the second plurality of goods-based recommendations is based on the third plurality of goods-based recommendations.

Example 7 includes the subject matter of Example 5 or 6, and optionally, wherein the import inspection recommendation information comprises goods-based recommendations of one or more of the plurality of goods-based sub-levels.

Example 8 includes the subject matter of any one of Examples 5-7, and optionally, wherein determining the entity-based recommendation comprises determining a plurality of entity-based sub-levels comprising at least a first entity-based sub-level and a second entity-based sub-level, wherein the first entity-based sub-level comprises a first plurality of entity-based recommendations based on the entity-based information, wherein the second entity-based sub-level comprises a second plurality of entity-based recommendations based on the first plurality of entity-based recommendations; and determining the entity-based recommendation based on the second plurality of entity-based recommendations.

Example 9 includes the subject matter of Example 8, and optionally, wherein determining the plurality of entity-based sub-levels comprises determining at least a third entity-based sub-level comprising a third plurality of entity-based recommendations based on the first plurality of entity-based recommendations, wherein the second plurality of entity-based recommendations is based on the third plurality of entity-based recommendations.

Example 10 includes the subject matter of Example 8 or 9, and optionally, wherein the import inspection recommendation information comprises entity-based recommendations of one or more of the plurality of entity-based sub-levels.

Example 11 includes the subject matter of any one of Examples 1-10, and optionally, wherein determining the import inspection recommendation corresponding to the imported shipment comprises selecting between a clear recommendation, an inspect recommendation, and a caution recommendation.

Example 12 includes the subject matter of any one of Examples 1-11, and optionally, wherein the import inspection recommendation information comprises information to define a graphic representation configured to display the plurality of import inspection recommendations to a user.

Example 13 includes the subject matter of any one of Examples 1-12, and optionally, wherein the one or more declared goods attributes comprises at least one of a declared goods classification attribute, a declared goods physical attribute, or a declared goods value attribute.

Example 14 includes the subject matter of any one of Examples 1-13, and optionally, wherein the one or more declared goods attributes comprises at least one of a Harmonized System (HS) product code, a gross weight, a quantity, a volume, or a goods description.

Example 15 includes the subject matter of any one of Examples 1-14, and optionally, wherein the one or more declared entity attributes comprises at least one of a declared exporter attribute, a declared forwarder attribute, a declared loading port attribute, declared vessel attribute, a declared discharging port attribute, a declared broker attribute, or a declared importer attribute.

Example 16 includes the subject matter of any one of Examples 1-15, and optionally, wherein the one or more declared entity attributes comprises at least one of an entity identifier (ID), an entity address, entity contact information, or entity web information.

Example 17 includes the subject matter of any one of Examples 1-16, and optionally, wherein the shipment document information corresponding to the imported shipment comprises Bill of Ladling (BOL) information of a BOL corresponding to the imported shipment.

Example 18 includes the subject matter of any one of Examples 1-17, and optionally, wherein the shipment document information corresponding to the imported shipment comprises declaration information of a declaration corresponding to the imported shipment.

Example 19 includes the subject matter of any one of Examples 1-18, and optionally, wherein the one or more databases comprises a web database.

Example 20 includes the subject matter of any one of Examples 1-19, and optionally, wherein the one or more databases comprises a local database.

Example 21 includes a product comprising one or more tangible computer-readable non-transitory storage media comprising instructions operable to, when executed by at least one processor, enable the at least one processor to cause a computing device to send to a server shipment document information corresponding to a plurality of imported shipments; identify, based on import inspection recommendation information from the server, a plurality of import inspection recommendations corresponding to the plurality of imported shipments, wherein an import inspection recommendation corresponding to an imported shipment is to indicate whether the imported shipment is to be cleared; and provide a Graphical User Interface (GUI) to a user, the GUI configured to present the plurality of import inspection recommendations corresponding to the plurality of imported shipments.

Example 22 includes the subject matter of Example 21, and optionally, wherein the shipment document information comprises a plurality of declared attributes for the imported shipment, the plurality of declared attributes comprising one or more declared goods attributes and one or more declared entity attributes.

Example 23 includes the subject matter of Example 22, and optionally, wherein the inspection recommendation information from the server comprises a goods-based recommendation for the imported shipment based on the declared goods attributes, and an entity-based recommendation for the imported shipment based on the declared entity attributes.

Example 24 includes the subject matter of Example 23, and optionally, wherein the instructions, when executed, cause the computing device to identify a selection of the imported shipment based on an input from the user, and, based on the selection of the imported shipment, to cause the GUI to present the goods-based recommendation for the imported shipment and the entity-based recommendation for the imported shipment.

Example 25 includes the subject matter of Example 24, and optionally, wherein the inspection recommendation information from the server comprises one or more expected goods-attributes corresponding to the one or more declared goods attributes, wherein the instructions, when executed, cause the computing device to, based on a request from the user for supportive information corresponding to the goods-based recommendation for the imported shipment, cause the GUI to present the one or more expected goods-attributes corresponding to the one or more declared goods attributes.

Example 26 includes the subject matter of Example 25, and optionally, wherein the instructions, when executed, cause the GUI to present a plurality of goods-based sub-levels comprising at least a first goods-based sub-level and a second goods-based sub-level, wherein the first goods-based sub-level comprises a first plurality of goods-based recommendations based on the one or more expected goods-attributes, wherein the second goods-based sub-level comprises a second plurality of goods-based recommendations based on the first plurality of goods-based recommendations, wherein the goods-based recommendation is based on the second plurality of goods-based recommendations.

Example 27 includes the subject matter of Example 26, and optionally, wherein the instructions, when executed, cause the GUI to present at least a third goods-based sub-level comprising a third plurality of goods-based recommendations based on the first plurality of goods-based recommendations, wherein the second plurality of goods-based recommendations is based on the third plurality of goods-based recommendations.

Example 28 includes the subject matter of any one of Examples 23-26, and optionally, wherein the inspection recommendation information from the server comprises one or more entity-reliability indicators corresponding to the one or more declared entity attributes, wherein the instructions, when executed, cause the computing device to, based on a request from the user for supportive information corresponding to the entity-based recommendation for the imported shipment, cause the GUI to present the one or more entity-reliability indicators corresponding to the one or more declared goods attributes.

Example 29 includes the subject matter of Example 28, and optionally, wherein the instructions, when executed, cause the GUI to present a plurality of entity-based sub-levels comprising at least a first entity-based sub-level and a second entity-based sub-level, wherein the first entity-based sub-level comprises a first plurality of entity-based recommendations based on the one or more entity-reliability indicators, wherein the second entity-based sub-level comprises a second plurality of entity-based recommendations based on the first plurality of entity-based recommendations, wherein the entity-based recommendation is based on the second plurality of entity-based recommendations.

Example 30 includes the subject matter of Example 29, and optionally, wherein the instructions, when executed, cause the GUI to present at least a third entity-based sub-level comprising a third plurality of entity-based recommendations based on the first plurality of entity-based recommendations, wherein the second plurality of entity-based recommendations is based on the third plurality of entity-based recommendations.

Example 31 includes the subject matter of any one of Examples 22-30, and optionally, wherein the one or more declared goods attributes comprises at least one of a declared goods classification attribute, a declared goods physical attribute, or a declared goods value attribute.

Example 32 includes the subject matter of any one of Examples 22-31, and optionally, wherein the one or more declared goods attributes comprises at least one of a Harmonized System (HS) product code, a gross weight, a quantity, a volume, or a goods description.

Example 33 includes the subject matter of any one of Examples 22-32, and optionally, wherein the one or more declared entity attributes comprises at least one of a declared exporter attribute, a declared forwarder attribute, a declared loading port attribute, declared vessel attribute, a declared discharging port attribute, a declared broker attribute, or a declared importer attribute.

Example 34 includes the subject matter of any one of Examples 22-33, and optionally, wherein the one or more declared entity attributes comprises at least one of an entity identifier (ID), an entity address, entity contact information, or entity web information.

Example 35 includes the subject matter of any one of Examples 21-34, and optionally, wherein the import inspection recommendation corresponding to the imported shipment comprises a clear recommendation, an inspect recommendation, or a caution recommendation.

Example 36 includes the subject matter of any one of Examples 21-35, and optionally, wherein the instructions, when executed, cause the GUI to present the plurality of import inspection recommendations according to a color-coded graphic representation, wherein the color-coded graphic representation is configured to present the import inspection recommendation corresponding to an imported shipment using a color selected from a predefined set of colors corresponding to a respective plurality of predefined import inspection recommendations.

Example 37 includes the subject matter of any one of Examples 21-36, and optionally, wherein the shipment document information comprises Bill of Ladling (BOL) information of a BOL corresponding to the imported shipment.

Example 38 includes the subject matter of any one of Examples 21-37, and optionally, wherein the shipment document information comprises declaration information of a declaration corresponding to the imported shipment.

Example 39 comprises a computing device configured to perform any of the described operations of any of Examples 1-38.

Example 40 comprises a computing system comprising one or more computing devices and/or servers configured to perform any of the described operations of any of Examples 1-38.

Example 41 comprises one or more apparatuses comprising means for executing any of the described operations of any of Examples 1-38.

Example 42 comprises a method comprising any of the described operations of any of Examples 1-38.

Functions, operations, components and/or features described herein with reference to one or more aspects, may be combined with, or may be utilized in combination with, one or more other functions, operations, components and/or features described herein with reference to one or more other aspects, or vice versa.

While certain features have been illustrated and described herein, many modifications, substitutions, changes, and equivalents may occur to those skilled in the art. It is, therefore, to be understood that the appended claims are intended to cover all such modifications and changes as fall within the true spirit of the disclosure.

What is claimed is:

1. A product comprising one or more tangible computer-readable non-transitory storage media comprising instructions operable to, when executed by at least one processor, enable the at least one processor to cause a computing system to:
process shipment document information corresponding to a plurality of imported shipments to automatically determine a plurality of import inspection recommendations corresponding to the plurality of imported shipments, wherein automatically determining the plurality of import inspection recommendations comprises automatically determining an import inspection recommendation corresponding to an imported shipment by:
processing shipment document information corresponding to the imported shipment to identify a plurality of declared attributes for the imported shipment, the plurality of declared attributes comprising one or more declared goods attributes and one or more declared entity attributes;
accessing one or more databases to retrieve attribute-based information corresponding to the plurality of declared attributes; and
determining the import inspection recommendation corresponding to the imported shipment based on the plurality of declared attributes and the attribute-based information, wherein the import inspection recommendation corresponding to the imported shipment is to indicate whether the imported shipment is to be cleared from an import inspection; and
provide an output comprising import inspection recommendation information based on the plurality of import inspection recommendations.

2. The product of claim 1, wherein the attribute-based information comprises goods-based information corresponding to the one or more declared goods attributes, wherein determining the import inspection recommendation corresponding to the imported shipment comprises determining one or more expected goods-attributes based on the goods-based information, and determining the import inspection recommendation corresponding to the imported shipment based on a comparison between the expected goods-attributes and the declared goods attributes.

3. The product of claim 1, wherein the attribute-based information comprises entity-based information corresponding to the one or more declared entity attributes, wherein determining the import inspection recommendation corresponding to the imported shipment comprises determining one or more entity-reliability indicators corresponding to the one or more declared entity attributes, and determining the import inspection recommendation corresponding to the imported shipment based on the one or more entity-reliability indicators.

4. The product of claim 1, wherein automatically determining the import inspection recommendation corresponding to the imported shipment comprises:
retrieving the attribute-based information comprising goods-based information corresponding to the one or more declared goods attributes, and entity-based information corresponding to the one or more declared entity attributes;
determining a goods-based recommendation based on the declared goods attributes and the goods-based information;
determining an entity-based recommendation based on the declared entity attributes and the entity-based information; and
determining the import inspection recommendation corresponding to the imported shipment based on the goods-based recommendation and the entity-based recommendation.

5. The product of claim 4, wherein determining the goods-based recommendation comprises:
determining a plurality of goods-based sub-levels comprising at least a first goods-based sub-level and a second goods-based sub-level, wherein the first goods-based sub-level comprises a first plurality of goods-based recommendations based on the goods-based information, wherein the second goods-based sub-level comprises a second plurality of goods-based recommendations based on the first plurality of goods-based recommendations; and
determining the goods-based recommendation based on the second plurality of goods-based recommendations.

6. The product of claim 5, wherein determining the plurality of goods-based sub-levels comprises determining at least a third goods-based sub-level comprising a third plurality of goods-based recommendations based on the first plurality of goods-based recommendations, wherein the second plurality of goods-based recommendations is based on the third plurality of goods-based recommendations.

7. The product of claim 5, wherein the import inspection recommendation information comprises goods-based recommendations of one or more of the plurality of goods-based sub-levels.

8. The product of claim 5, wherein determining the entity-based recommendation comprises:
determining a plurality of entity-based sub-levels comprising at least a first entity-based sub-level and a second entity-based sub-level, wherein the first entity-based sub-level comprises a first plurality of entity-based recommendations based on the entity-based information, wherein the second entity-based sub-level comprises a second plurality of entity-based recommendations based on the first plurality of entity-based recommendations; and
determining the entity-based recommendation based on the second plurality of entity-based recommendations.

9. The product of claim 8, wherein determining the plurality of entity-based sub-levels comprises determining at least a third entity-based sub-level comprising a third plurality of entity-based recommendations based on the first plurality of entity-based recommendations, wherein the second plurality of entity-based recommendations is based on the third plurality of entity-based recommendations.

10. The product of claim 8, wherein the import inspection recommendation information comprises entity-based recommendations of one or more of the plurality of entity-based sub-levels.

11. The product of claim 1, wherein determining the import inspection recommendation corresponding to the imported shipment comprises selecting between a clear recommendation, an inspect recommendation, and a caution recommendation.

12. The product of claim 1, wherein the one or more declared goods attributes comprises at least one of a declared goods classification attribute, a declared goods physical attribute, or a declared goods value attribute.

13. The product of claim 1, wherein the one or more declared entity attributes comprises at least one of a declared exporter attribute, a declared forwarder attribute, a declared loading port attribute, declared vessel attribute, a declared discharging port attribute, a declared broker attribute, or a declared importer attribute.

14. The product of claim 1, wherein the shipment document information corresponding to the imported shipment comprises Bill of Ladling (BOL) information of a BOL corresponding to the imported shipment.

15. The product of claim 1, wherein the shipment document information corresponding to the imported shipment comprises declaration information of a declaration corresponding to the imported shipment.

16. The product of claim 1, wherein the one or more databases comprises at least one of a web database, or a local database.

17. A method comprising:
processing shipment document information corresponding to a plurality of imported shipments to automatically determine a plurality of import inspection recommendations corresponding to the plurality of imported shipments, wherein automatically determining the plurality of import inspection recommendations comprises automatically determining an import inspection recommendation corresponding to an imported shipment by:
processing shipment document information corresponding to the imported shipment to identify a plurality of declared attributes for the imported shipment, the plurality of declared attributes comprising one or more declared goods attributes and one or more declared entity attributes;
accessing one or more databases to retrieve attribute-based information corresponding to the plurality of declared attributes; and
determining the import inspection recommendation corresponding to the imported shipment based on the plurality of declared attributes and the attribute-based information, wherein the import inspection recommendation corresponding to the imported shipment is to indicate whether the imported shipment is to be cleared from an import inspection; and
providing an output comprising import inspection recommendation information based on the plurality of import inspection recommendations.

18. The method of claim 17, wherein automatically determining the import inspection recommendation corresponding to the imported shipment comprises:
retrieving the attribute-based information comprising goods-based information corresponding to the one or more declared goods attributes, and entity-based information corresponding to the one or more declared entity attributes;
determining a goods-based recommendation based on the declared goods attributes and the goods-based information;
determining an entity-based recommendation based on the declared entity attributes and the entity-based information; and
determining the import inspection recommendation corresponding to the imported shipment based on the goods-based recommendation and the entity-based recommendation.

19. A system comprising:
a server configured to process shipment document information corresponding to a plurality of imported shipments to automatically determine a plurality of import inspection recommendations corresponding to the plurality of imported shipments, wherein the server is configured to provide an output comprising import inspection recommendation information based on the plurality of import inspection recommendations, wherein the server is configured to automatically determine the plurality of import inspection recommendations by automatically determining an import inspection recommendation corresponding to an imported shipment by:
processing shipment document information corresponding to the imported shipment to identify a plurality of declared attributes for the imported shipment, the plurality of declared attributes comprising one or more declared goods attributes and one or more declared entity attributes;
accessing one or more databases to retrieve attribute-based information corresponding to the plurality of declared attributes; and
determining the import inspection recommendation corresponding to the imported shipment based on the plurality of declared attributes and the attribute-based information, wherein the import inspection recommendation corresponding to the imported shipment is to indicate whether the imported shipment is to be cleared from an import inspection; and
a local database.

20. The system of claim 19, wherein the server is configured to:
retrieve the attribute-based information comprising goods-based information corresponding to the one or more declared goods attributes, and entity-based information corresponding to the one or more declared entity attributes;
determine a goods-based recommendation based on the declared goods attributes and the goods-based information;
determine an entity-based recommendation based on the declared entity attributes and the entity-based information; and
determine the import inspection recommendation corresponding to the imported shipment based on the goods-based recommendation and the entity-based recommendation.
